(19) United States
(12) Patent Application Publication
(10) Pub. No.: US 2026/0066338 A1
(43) Pub. Date: Mar. 5, 2026

(54) SYSTEMS AND METHODS FOR LITHIUM METAL DEPOSITION

(71) Applicant: Pure Lithium Corporation, Charlestown, MA (US)

(72) Inventors: Donald R. SADOWAY, Boston, MA (US); Paul J. BURKE, Marlborough, MA (US)

(21) Appl. No.: 19/196,599

(22) Filed: May 1, 2025

Related U.S. Application Data
(63) Continuation-in-part of application No. 17/832,321, filed on Jun. 3, 2022, now abandoned.
(63) Continuation-in-part of application No. 17/832,336, filed on Jun. 3, 2022, now abandoned.
(63) Continuation-in-part of application No. 17/951,693, filed on Sep. 23, 2022, now abandoned.
(63) Continuation-in-part of application No. 17/581,545, filed on Jan. 21, 2022, now abandoned.
(60) Provisional application No. 63/148,422, filed on Feb. 11, 2021.
(60) Provisional application No. 63/197,091, filed on Jun. 4, 2021.
(60) Provisional application No. 63/197,091, filed on Jun. 4, 2021.
(60) Provisional application No. 63/221,546, filed on Jul. 14, 2021.
(60) Provisional application No. 63/221,546, filed on Jul. 14, 2021.
(60) Provisional application No. 63/248,704, filed on Sep. 27, 2021.

(51) Int. Cl. H01M 10/056; C22B 7/00; C22B 26/12; C25D 5/12; C25D 21/12; H01M 10/0525

(52) U.S. Cl. CPC H01M 10/056; C22B 7/001; C22B 26/12; C25D 5/12; C25D 21/12; H01M 10/0525; H01M 2300/0022; H01M 2300/0082

(57) ABSTRACT

Provided are a conformable polymer coated lithium metal electrode, a solid electrolyte, and an inorganic molten salt electrolyte for a rechargeable lithium metal battery. Systems and methods are also provided for controlling the electroplating of lithium metal onto negative electrodes to allow for more rapid recharging of lithium metal batteries while minimizing dendrite formation.

### CROSS-REFERENCE

This application is a continuation-in-part application of Ser. No. 17/832,321, filed Jun. 3, 2022, Ser. No. 17/832,336, filed Jun. 3, 2022, Ser. No. 17/951,693, filed Sep. 23, 2022, and Ser. No. 17/581,545, filed Jan. 21, 2022, each of which is incorporated herein by reference in its entirety. The application Ser. No. 17/832,321, filed Jun. 3, 2022, claims the benefit of U.S. Provisional Application No. 63/197,091, filed Jun. 4, 2021, and U.S. Provisional Application No. 63/221,546, filed Jul. 14, 2021. The application Ser. No. 17/832,336, filed Jun. 3, 2022, claims the benefit of U.S. Provisional Application No. 63/197,091, filed Jun. 4, 2021, and U.S. Provisional Application No. 63/221,546, filed Jul. 14, 2021. The application Ser. No. 17/951,693, filed Sep. 23, 2022, claims the benefit of U.S. Provisional Application No. 63/248,704, filed Sep. 27, 2021. The application Ser. No. 17/581,545, filed Jan. 21, 2022, claims the benefit of U.S. Provisional Application No. 63/148,422, filed Feb. 11, 2021.

### BACKGROUND

Lithium ion batteries (LIBs) dominate automotive and small electronics markets. LIBs contain no metallic lithium present as such. The negative electrode comprises a carbon host for neutral lithium which is contained therein. In the electrolyte and in the positive electrode, lithium is present only as the ion. Such batteries are attractive for their high energy density compared to that of other rechargeable batteries and for their ability to operate over multiple charge/discharge cycles. However, the organic electrolytes typically used in LIBs are volatile, flammable and are a safety hazard if the batteries overheat. Moreover, lithium-ion batteries typically use intercalation-type positive electrodes, which undergo volumetric changes during cycling, suffer from attendant decrepitation, leading to capacity fade.

In lithium metal batteries (LMBs), the negative electrode comprises metallic lithium. During discharge of an LMB, lithium metal dissociates to form lithium ions and electrons. The lithium ions migrate through the electrolyte to the positive electrode. The electrons flow through an external circuit where they power a device. As the LMB recharges, lithium ions are reduced back to lithium metal as electrons flow back into the negative electrode. Because LMBs have intrinsically higher capacity than LIBs, they are the preferred technology for primary batteries. Moreover, since LMBs can be manufactured in the fully charged state, they do not require the lengthy formation process needed for LIBs. However, poor cycle life, volumetric expansion, and safety concerns relating to shorts resulting from dendrite formation and the potential for violent combustion of flammable organic electrolytes have limited the practical use of LMBs as rechargeable batteries.

A limitation of both LIBs and LMBs is that lithium is a limited natural resource, widely dispersed on the earth, but typically in low concentration. Moreover, lithium availability and cost depend on politically fragile supply chains. Also, while a high specific capacity is desired for automotive applications, for applications such as stationary energy storage, cost is the more important factor. For such applications, battery technologies based on materials that are cheaper and more highly abundant than the materials used in lithium batteries are desirable.

To address the growing electrical energy storage demands of the 21st century, there is a pressing need for advancements in rechargeable battery technologies, including LMBs and other systems that utilize inexpensive and abundant materials. Key improvements sought in these technologies include enhanced electrochemical efficiency, reduced costs, extended cycle life, and improved safety profiles.

LIBs are ubiquitous in consumer electronics, and power electrical vehicles. Battery lifetimes are typically less than three years in consumer electronics, and between five to ten years in electric vehicles. With an estimated 140 million electric vehicles predicted to be on the road by 2030, the demand for LIBs is growing by leaps and bounds—as is the demand for the critical metals required for LIB manufacture. In addition to lithium, critical metals present as metal oxides in the cathodes of lithium-ion batteries include cobalt, manganese, and nickel. Cobalt is present at a concentration of up to 15% in lithium ion battery cathodes, and contributes significantly to the cost of battery production. The primary sources of cobalt are from regions associated with human rights concerns and political instability. Cobalt is also associated with environmental toxicity, which needs to be considered for any proposed recycling methods.

And yet less than 5% of LIBs are currently recycled, with the majority ending up in landfills, wasting valuable resources, and potentially leaching heavy metals. Urgent economic and environmental needs exist for improved methods of recovery of high value metals from batteries.

LMBs have intrinsically higher capacity than LIBs, and are thus the preferred technology for primary batteries. However, rechargeable LMBs tend to form dendrites on the lithium metal electrode, which can short batteries, leading to reduced battery life and the potential for hazardous combustion. Lithium metal electrodes comprise a flat conductive substrate, typically copper, that functions as a current collector, onto which lithium metal is deposited.

During electrodeposition on an electrode surface, nonuniform current distributions may occur at defects and/or result from random processes. Stochastic variations in current and voltage over time and space on the electrode may in turn lead to uneven distribution of deposited lithium, and eventually can promote dendrite formation. Dendrite formation during recharging places limits both on battery lifetime and on the speed at which batteries can be recharged. In order to increase battery lifetime and efficiency, and to reduce charging times, a need exists for inexpensive methods to monitor and control dendrite formation during battery charging.

LMBs using sulfur as the positive electrode offer higher specific capacity than the lithium intercalation compounds that currently dominate the market. However, complex polysulfide species produced upon the reduction of elemental sulfur are soluble in the organic electrolytes typically used in lithium batteries, resulting in reduced electrochemical performance and cycle life due to the “polysulfide shuttle” effect.

Solid state electrolytes (SSEs) are believed to ameliorate the safety concerns for lithium batteries, and to reduce polysulfide reduction processes at the negative electrode that degrade battery performance and cycle life. However, SSEs can also result in high impedance at the positive electrode, thereby reducing output voltage and hence battery efficiency.

Inorganic molten salts provide another electrolyte alternative, with non-flammability and high ionic conductivities as attractive attributes. Inorganic molten salts can make use of common inexpensive materials. However, the choices of inorganic molten salts that can serve as solvents for lithium ions are limited by the low, i.e., cathodic, reduction potential of lithium ion compared to that of other metallic cations, meaning that most common low temperature inorganic molten salts incorporate the salts of metals that are more noble than lithium and will thus preferentially electroplate to it during battery recharging.

Low temperature ionic liquids with complex organic cations provide some of the benefits of inorganic molten salts, but are significantly more expensive, and have decreased ionic conductivities compared to those of inorganic molten salts.

A novel rechargeable lithium metal battery and methods to produce the same are needed to improve the electrochemical efficiency, increase cycle life and enhance the safety profile of rechargeable lithium metal batteries, in particular lithium metal batteries using elemental sulfur in the positive electrode.

### SUMMARY

Provided herein is a rechargeable metal displacement battery. In some embodiments, the rechargeable metal displacement battery comprises a negative electrode, a positive electrode, a solid electrolyte, and a molten salt electrolyte. In some embodiments, the negative electrode comprises a conductive substrate coated with a layer of a first metal having an inner face and an outer face. In some embodiments, the inner face is configured to contact the conductive substrate. In some embodiments, the positive electrode comprises a second metal. In some embodiments, the solid electrolyte comprises a conformable polymer that preferentially conducts ions of the first metal compared to ions of the second metal, and that coats the outer face of the layer of the first metal. In some embodiments, the molten salt electrolyte is a mixture of inorganic salts comprising a first salt of the first metal and a salt of the second metal. In some embodiments, the melting temperature of the molten salt electrolyte is less than 140° C. In some embodiments, the molten salt electrolyte is disposed between the solid electrolyte and the positive electrode, and is in direct physical contact with both the solid electrolyte and the positive electrode. In some embodiments, the first metal is more electropositive than the second metal.

In some embodiments, the conformable polymer is a graft or block copolymer with a first segment and a second segment, wherein each segment of the first and second segments is above its respective glass transition temperature, Tg, wherein the first segment is formed from groups configured to solvate a second salt of the first metal and the second segment is immiscible with the first segment, and wherein the second salt of the first metal is dispersed within the solid electrolyte.

In some embodiments, the first metal is selected from the group consisting of an alkali metal, an alkaline earth metal, and aluminum. In some embodiments, the second metal is selected from the group consisting of Fe, Ni, Bi, Pb, Zn, Sn, and Cu.

In some embodiments, the mixture of inorganic salts comprises one or more salts selected from the group consisting of aluminum salts, titanium salts, iron salts, alkali metal salts, alkaline earth metal salts, ammonium salts, and combinations thereof. In some embodiments, the mixture of inorganic salts comprises aluminum salts, and wherein the molar percentage of the aluminum salts is at least 50%. In some embodiments, the mixture of inorganic salts comprises iron salts, and wherein the molar percentage of the iron salts is at least 50%.

In some embodiments, the mixture of inorganic salts comprises anions chosen from the group consisting of halides, nitrates, nitrites, sulfates, sulfites, carbonates, hydroxides, and combinations thereof. In some embodiments, the mixture of inorganic salts comprises aluminum chloride, wherein the molar percentage of aluminum chloride is at least 50%. In some embodiments, the mixture of inorganic salts comprises ferric chloride, wherein the molar percentage of ferric chloride is at least 50%.

In some embodiments, the second metal is elemental aluminum, the first metal is elemental lithium, and the mixture of inorganic salts comprises aluminum chloride, wherein the molar percentage of aluminum chloride is at least 50%. In some embodiments, the second metal is elemental iron, the first metal is elemental lithium, and the mixture of inorganic salts comprises aluminum chloride (AlCl₃) and ferric chloride (FeCl₃), wherein the sum of the molar percentages of aluminum chloride and ferric chloride is at least 50%. In some embodiments, second metal is elemental iron, the first metal is elemental aluminum, and the mixture of inorganic salts comprises aluminum chloride (AlCl₃) and ferric chloride (FeCl₃), wherein the sum of the molar percentages of aluminum chloride and ferric chloride is at least 50%.

In some embodiments, the conformable polymer is a block copolymer. In some embodiments, the conformable polymer is a graft copolymer. In some embodiments, the first segments of the block or graft copolymer comprise poly(oxyethylene)ₙ side chains, wherein n is an integer between 4 and 20. In some embodiments, the first segments of the block copolymer comprise poly(oxyethylene)ₙ side chains, where n is an integer between 4 and 20, and the second segments of the block copolymer comprise poly(alkyl methacrylate). In some embodiments, the first segments of the graft copolymer comprise poly(oxyethylene)n side chains, where n is an integer between 4 and 20, and the second segments of the graft copolymer comprise poly(dimethyl siloxane). In some embodiments, the block copolymer comprises poly[(oxyethylene)9 methacrylate]-b-poly(laurel methacrylate) (POEM-b-PLMA). In some embodiments, the graft copolymer comprises poly[(oxyethylene)₉ methacrylate]-g-poly(dimethyl siloxane). In some embodiments, the ratio of POEM to PLMA is between 55:45 and 70:30 on a molar basis.

In some embodiments, the melting temperature of the molten salt electrolyte is less than 100° C. In some embodiments, the melting temperature of the molten salt electrolyte is less than 75° C. In some embodiments, the melting temperature of the molten salt electrolyte is less than 50° C. In some embodiments, the melting temperature of the molten salt electrolyte is less than 30° C.

Provided herein is a method of electrodepositing lithium, comprising: providing an electrochemical cell comprising a negative electrode, a positive electrode, an electrolyte, and lithium ions; and electrodepositing, while monitoring electrochemical noise of the electrochemical cell, lithium ions as lithium metal onto the negative electrode by applying an electrical potential or current between the negative electrode and the positive electrode, wherein the electrical potential or current is modulated based on the electrochemical noise.

In some embodiments, the electrochemical cell is within a rechargeable lithium metal battery. In some embodiments, the electrical potential is applied as a combination of (i) a constant electrical potential or current and (ii) an alternating electrical potential or current. In some embodiments, the alternating electrical potential or current is modulated based on the electrochemical noise. In some embodiments, the alternating electrical potential or current is modulated in real-time based on the electrochemical noise. In some embodiments, the electrical potential or current is modulated based on the electrochemical noise when the electrochemical noise provides a signature of dendrite formation in the lithium metal. In some embodiments, the electrical potential or current is modulated in frequency, phase, amplitude, or wave shape based on the electrochemical noise.

In some embodiments, the signature of dendrite formation is a spectral signature. In some embodiments, the spectral signature is detected in real-time. In some embodiments, the spectral signature is detected in a power spectrum of the electrochemical noise. In some embodiments, the spectral signature is detected in a Fourier transform of the electrochemical noise. In some embodiments, the spectral signature is detected in a Laplace transform of the electrochemical noise. In some embodiments, the electrical potential or current is modulated to eliminate dendrites. In some embodiments, the electrical potential or current is modulated to reduce the formation of dendrites.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (“FIGURE.” or “FIGURES.” herein) of which:

FIG. 1 illustrates the structural features of block and graft copolymers.

FIG. 2 embodies an electropositive metal battery constructed with a single conformable polymer coated negative electrode and a single positive electrode.

FIG. 3 embodies an electropositive metal battery constructed with a single conformable polymer coated negative electrode and two positive electrodes.

FIG. 4 shows steps for producing an electropositive metal electrode according to embodiments of the present disclosure.

FIG. 5 shows an electrolytic cell for producing an electropositive metal electrode according to embodiments, prior to the application of electroplating current.

FIG. 6 shows the electrolytic cell of FIG. 5 after the application of electroplating current.

FIG. 7a provides a cross-sectional view of a conformable polymer coated conductive substrate prior to electroplating electropositive metal onto the substrate according to embodiments of the present disclosure.

FIG. 7b provides a top view of a conformable polymer coated conductive substrate prior to electroplating electropositive metal onto the substrate according to embodiments of the present disclosure.

FIG. 8a provides a cross-sectional view of the conductive substrate of FIGS. 7a and 7b after electroplating electropositive metal onto the substrate to form an electropositive metal layer sandwiched between the conductive substrate and the conformable polymer coating according to embodiments of the present disclosure.

FIG. 8b provides a top view of the conductive substrate of FIG. 8a according to embodiments of the present disclosure.

FIG. 9 embodies a method of extracting transition metals from lithium battery cathodes by dissolution in a glass-forming oxide melt and recovery of the extracted metal by electroplating.

FIG. 10 embodies an extraction vessel configured to extract transition metal oxide from scrap material by dissolution in a glass-forming oxide melt.

FIG. 11 embodies an electrolytic cell configured to electroplate transition metal that has been dissolved in a glass-forming oxide melt onto a cathode. Oxygen is produced at the anode of the electrolytic cell.

FIG. 12 embodies an extraction cell configured to reduce transition metal oxides to elemental transition metals onto a molten metal cathode, thereby forming a liquid alloy with the molten metal cathode, and generating oxygen at the anode.

FIG. 13 embodies a refining cell for electroplating transition metals onto an electrically conductive substrate configured as a cathode. The cell is shown prior to electrolysis.

FIG. 14 embodies a refining cell of FIG. 13 upon completion of electrolysis.

FIG. 15 embodies a method of extracting lithium from lithium battery scrap, prior to extracting transition metal from the scrap.

FIG. 16 embodies an electrolytic cell for recovering lithium from lithium battery scrap and providing lithium depleted battery scrap for further processing. The cell is shown prior to electrolysis.

FIG. 17 embodies the electrolytic cell of FIG. 16 upon completion of electrolysis.

FIG. 18 provides a schematic diagram of a method of controlled electroplating according to an embodiment of the disclosure.

FIG. 19 provides a diagram of an electroplating system according to an embodiment of the disclosure.

### DETAILED DESCRIPTION

In certain aspects, the present disclosure relates to the manufacture of lithium metal rechargeable batteries using inorganic molten salts. The resultant batteries are safer and have increased cycle life compared to lithium metal batteries manufactured by conventional methods. In certain aspects, the present disclosure also relates to systems and methods for modulating the surface features of metals electrodeposited on conductive substrates. Aspects of the present disclosure relate to minimizing dendrite growth during secondary battery charging, in particular for lithium metal batteries. Also provided herein is the cost-effective and environmentally benign recovery of transition metals from battery scrap, in particular from rechargeable lithium battery electrodes.

Various embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure.

Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “exemplary” as used herein means “serving as an example, instance, or illustration.” Any embodiment described herein as “exemplary” is not to be construed as preferred or advantageous over other embodiments.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative or quantitative and qualitative determinations. Assessing can be relative or absolute. “Detecting the presence of” can include determining the amount of something present in addition to determining whether it is present or absent depending on the context.

As used herein, the term “about” a number refers to that number plus or minus 10% of that number. The term “about” a range refers to that range minus 10% of its lowest value and plus 10% of its greatest value.

An “electrolyte” is a material that conducts ionic charge.

A “positive electrode” is the anode in an electrolytic cell, and the cathode in a galvanic cell.

A “negative electrode” is the cathode in an electrolytic cell and the anode in a galvanic cell. Consequently, a lithium metal electrode in a lithium metal battery is always a “negative electrode” even though it is a cathode during charging and an anode during discharging.

A “solid electrolyte” is solid material that allows ion transport between electrodes of an electrolytic or galvanic cell. As used herein, the term “solid electrolyte” is understood to include a material such as a gel or a conformable polymer, that has microscopic regions with liquid-like behavior, but that maintains its overall shape.

A “lithium battery” is a lithium-ion or a lithium metal battery.

As used herein, a “lithium metal electrode” and a “lithium electrode” are synonymous, and each refers to a negative electrode comprising lithium metal.

A “lithium metal battery” (or “LMB”) is a battery that utilizes a negative electrode comprising pure lithium metal (i.e. a lithium metal electrode).

“Charging” of a lithium metal battery is the process of electrolytically depositing lithium metal on the negative electrode of the battery.

“Discharging” of a lithium metal battery is the process of connecting the battery to an external circuit and allowing current to flow between the positive and the negative electrodes, thereby providing a source of electrical energy that can be used to perform work.

“Noise” is the fluctuation of a signal with time compared to the mean of the signal.

A “molten salt” is a mixture of salts above its melting point, present as a liquid phase that is ionically conductive. A “molten salt” is an electrolyte by virtue of its ionic conductivity.

An “ionic liquid” is a room-temperature molten salt. In some embodiments, the ionic liquid includes, but is not limited to, bulky organic cations such as the 1-ethyl-3-methylimidazolium (EMIM) cation, for example EMIM:Cl and EMIM:Ac (acetate anion).

An “inorganic molten salt” is an inorganic salt composition above its melting temperature. In some embodiments, the inorganic molten salts include, but are not limited to, metal halides, e.g., sodium chloride (NaCl), and metal nitrates, e.g., silver nitrate (AgNO3).

A “block copolymer” is a polymer with blocks made up of one monomer alternating with blocks of another monomer along a linear polymer strand.

A “graft copolymer” is a polymer which has a backbone strand made up of one type of monomer and branches of a second monomer.

As used herein, a “conformable polymer” is an amorphous elastomeric polymer above its glass transition temperature, capable of extensive molecular rearrangement, allowing the polymer to stretch and retract in response to macroscopic stress. When present as a coating on a substrate, such a conformable polymer has the mechanical properties of a solid, but can shrink and expand to adapt to volume changes of the substrate, while continuing to coat the substrate. The block and graft copolymers of the present disclosure are “conformable polymers.”

A “segment” is a block in the case of a block copolymer and a side chain or backbone in the case of a graft copolymer.

“Microphase separation” of a block or graft copolymer occurs when polymer chains segregate into domains so as to according to the compositions of their monomeric units.

A “cosolvent” for different monomers is a solvent capable of dissolving each of the different segments of a block or graft copolymer.

A “common solvent” is identical with a “cosolvent.”

A “negative electrode” functions as an anode in a galvanic cell and as a cathode in an electrolytic cell.

A “positive electrode” functions as a cathode in a galvanic cell and as an anode in an electrolytic cell.

The “reduction potential” of a chemical species provides a measure in volts, of the tendency of the chemical species to undergo electrochemical reduction by accepting electrons. A higher reduction potential implies a greater tendency to accept electrons and be reduced. A metal that is more “noble” has a greater tendency to keep its electrons, so as to behave as less reactive, and the cations of that metal have a higher reduction potential when compared to the cations of a metal that is less “noble” or more reactive.

Lithium cation has one of the lowest, i.e., most negative, reduction potentials of all metal cations. In other words, lithium is one of the least “noble” metals. For metals, less “noble” is synonymous with more electropositive or more reactive.

A “bi-electrolyte electrochemical cell” as set forth herein is an electrochemical cell that incorporates both an inorganic molten salt electrolyte and an ion-selective SSE, the ion-selective SSE covering the negative electrode of the cell.

A “metal displacement battery” as used herein refers to a rechargeable battery for which the negative electrode comprises a first metal and the positive electrode comprises a second metal, for which the first metal has a lower reduction potential, i.e., is more cathodic, than that of the second metal.

“Decrepitation” as used herein refers to the cracking of intercalation-type positive electrodes as a result of volume changes during repeated recycling.

A “glass-forming oxide” is an oxide capable of forming a glass when cooled from the molten state. Examples of glass-forming oxides include borate (B₂O₃) and pyrophosphate (Na₄P₂O₇).

A “glass-forming oxide melt” is a high temperature molten state of a glass forming oxide, which may include dissolved compounds such as Na₂O, NaF, and salts of transition metal oxides.

A “power spectrum” is the Fourier transform of the autocorrelation function of a time domain signal into the frequency domain. In the present context, the power spectrum represents the conversion of voltage fluctuations in time (“noise”) into the frequency dependence of voltage fluctuations.

The section headings used herein are for organizational purposes only and are not to be construed as limiting the subject matter described.

### Molten Salt Electrolyte

The tendency for lithium metal batteries to form dendrites can lead to electrical shorting across the cell. The common use of flammable organic electrolytes for such batteries exacerbates the potential of such shorts to lead to fires and explosions. Solid electrolytes are generally less flammable, and can be designed for ion selectivity. Solid electrolytes in intimate contact with lithium metal electrodes can limit dendrite formation, thereby extending battery life. Solid electrolytes may be less flammable compared to organic electrolytes, and can be designed for ion selectivity. However, conventional solid electrolytes composed of ion selective ceramic materials are fragile, brittle and prone to fracture due to volume changes in the adjoining electrodes during charging and discharging cycles. Moreover, the interface between solid electrolytes and electrode surfaces can provide a significant impedance barrier, reducing output voltage and hence battery efficiency.

The ideal solid electrolyte has the ion transport properties of a liquid, the ability to preferentially transport desired ionic species, while blocking the undesirable transport of any other species including electrons. The ideal solid electrolyte is not flammable and is resistant to dendrite formation. The ideal solid electrolyte has the mechanical properties of a solid, but has elastomeric properties that allow it to accommodate electrode volume changes associated with battery charging and discharging while still maintaining physical contact with the electrode.

The present disclosure provides solid electrolytes of improved design, incorporating ion-selective conformable polymers, approach ideal solid electrolyte behavior.

Inorganic molten salt electrolytes have excellent ionic conductivities and low flammability. However, due to their high melting points, inorganic molten salt electrolytes for lithium batteries are typically limited to high temperatures under which conditions specialty battery containment materials are required so as to resist chemical attack. Moreover, because the melting temperature of lithium metal is 180.5° C., cells operating at these temperatures can potentially leak highly reactive molten lithium. The use of ionic liquid electrolytes with melting temperatures below room temperature can overcome some of these problems, but such electrolytes are expensive, and have reduced charge transfer rates and reduced diffusion coefficients compared to those of inorganic molten salts.

In some embodiments, compositions of inorganic molten salts have melting temperatures (Tₘ) below 140° C. In some embodiments, inorganic molten salts comprise solutions of AlCl₃. In some embodiments, inorganic molten salts comprise LiCl, NaCl, or KCl. Some such embodied chloroaluminate molten salt electrolytes can operate at temperatures at or near the boiling point of water. In other embodiments, inorganic molten salts formed from nitrate salts likewise have Tₘ well below 100° C.

In some embodiments, the inorganic molten salt electrolytes are non-flammable. Because these inorganic molten salt electrolytes operate at temperatures well below the melting point of lithium, they are not significantly corrosive, and there is no danger from the leakage of molten lithium.

In order to obtain low Tₘ inorganic molten salts, in some embodiments, inorganic species are incorporated into the inorganic molten salts that have higher reduction potentials than lithium cation. Even though those species would ordinarily electroplate preferentially compared to lithium, they are blocked from doing so by the layer of conformable polymer functioning as a solid electrolyte.

In some embodiments, the negative electrode of a lithium metal electrochemical cell is protected with a layer of conformable polymer that provides lithium ion selectivity, allowing the use of low Tₘ inorganic molten salt electrolytes comprising ionic species with a higher reduction potential than that of Li⁺. In some embodiments, lithium metal batteries are constructed with conformable polymer coated negative electrodes, and with a low Tₘ inorganic molten salt electrolyte between the polymer and the positive electrode. This enables the facile ion transport through liquid-like lithium channels of the conformable polymer at the negative electrode, and the ability of the inorganic molten salt electrolyte to penetrate the pores of the positive electrode, that together provide a high energy density, low impedance barrier battery, with a significantly improved cycle life, reduced threat of dendrite formation, and enhanced safety profile. The ability of the conformable polymer to undergo molecular rearrangements to adjust to volume changes and to self-heal if damaged reduces the detrimental effects of such volume changes during cycling, further enhancing battery life.

Lithium sulfur (Li-S) batteries using sulfur as the positive electrode offer higher specific capacity than the lithium intercalation compounds that currently dominate the market. However, complex polysulfide species produced upon the reduction of elemental sulfur dissolve in the organic electrolytes typically used in lithium batteries, resulting in reduced cycle life due to the “polysulfide shuttle” effect. The polysulfide shuttle effect is reduced for batteries according to the present disclosure. Without being bound by theory, this reduction is hypothesized to result from reduced solubility of polysulfide species in the inorganic molten salt electrolyte, combined with blockage of polysulfide transport by the conformable polymer solid state electrolyte.

In some embodiments, lithium metal batteries disclosed herein is configured to block the “polysulfide shuttle” between the positive and negative electrodes that reduces battery performance and cycle life of Li-S batteries.

Lithium cation has one of the lowest, i.e., most negative and therefore most cathodic, reduction potentials of all metal cations. In other words, lithium is one of the most electropositive and least “noble” metals. Other highly electropositive metals include sodium, magnesium and aluminum.

The tendency for metal batteries to form dendrites can lead to electrical shorting across the cell. Such shorts can lead to fires and explosions, in particular for metal batteries that incorporate flammable organic electrolytes. Solid electrolytes in intimate contact with metal electrodes can limit dendrite formation, thereby extending battery life. Solid electrolytes are less flammable compared to organic electrolytes, and can be designed for ion selectivity. However, conventional solid electrolytes composed of ion-selective ceramic materials are fragile, brittle and prone to fracture due to volume changes in the adjoining electrodes during charging and discharging cycles. Moreover, the interface between solid electrolytes and electrode surfaces can provide a significant impedance barrier, reducing output voltage and hence battery efficiency.

The ideal solid electrolyte has the ion transport properties of a liquid, and the ability to preferentially transport desired ionic species, while blocking the undesirable transport of any other species including electrons. The ideal solid electrolyte is not flammable and is resistant to dendrite formation. The ideal solid electrolyte has the mechanical properties of a solid, but has elastomeric properties that allow it to accommodate electrode volume changes associated with battery charging and discharging while still maintaining physical contact with the electrode. As embodiments of the present disclosure demonstrate, solid electrolytes of improved design, incorporating ion-selective conformable polymers, approach ideal solid electrolyte behavior.

In preferred embodiments of the present disclosure, a block or graft copolymer is incorporated as an ion-selective conformable polymer solid-state electrolyte. According to some such embodiments, the block or graft copolymer has one or more “A” segments of more hydrophilic polymers capable of solvating electropositive metal salts, interspersed with one or more “B” segments of more hydrophobic polymers. All segments are above their respective glass transition temperatures, Tg. Material comprising such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous metal ion solvating channels. For metal ion solvating chains having suitably high local chain mobility, high electrical conductivity allows the directed flow of metal ions through the copolymer upon application of an electric field. Doping the copolymer with a salt of the electropositive metal of the negative electrode according to embodiments of the present disclosure ensures selectivity for doped cations.

Inorganic molten salt electrolytes have excellent ionic conductivities and low flammability. However, due to their high melting points, molten salt electrolytes suitable for electropositive metal batteries are typically limited to dangerously high temperatures, under which conditions they can rapidly corrode conventional battery containment materials.

Moreover, because the melting temperature of lithium metal is 180.5° C. and the melting temperature of sodium metal is 97.79° C. cells operating at such high temperatures can potentially leak highly reactive molten lithium and sodium metal. The use of ionic liquid electrolytes with melting temperatures below room temperature can overcome some of these problems, but typically include expensive organic ions, and have reduced charge transfer rates compared to those of inorganic molten salts.

Compositions of inorganic molten salts according to embodiments of the present disclosure have melting temperatures (Tins) below 140° C. In some embodiments, the inorganic molten salts have Tins below 100° C., below 80° C., below 60° C., below 40° C., below 30° C., below 10° C.

Molten salt compositions according to some embodiments of the present disclosure include salts of electropositive metals, including but not limited to Li, Na, K, Mg and Ca. Some embodiments include salts of more electronegative metals including but not limited to Ti, Fe, Ni, Bi, Pb, Zn, Sn, and Cu. Some embodiments include halometallate molten salt compositions. Some preferred embodiments include haloaluminate molten salt compositions of AlX₃, where X is a halide. In some embodiments, X is Cl, and the molten salts include chloroaluminate salts. Some inorganic molten salts include ammonium salts. Some preferred embodiments include haloferrate molten salt compositions of FeX₃. In some embodiments, X is Cl, and the molten salts include chloroferrate salts. For some embodiments, molten salt compositions include inorganic nitrate salts.

The molten salt electrolytes of the present disclosure are non-flammable, and are liquid at temperatures well below the melting point of lithium, sodium, magnesium, and aluminum. Consequently, for embodiments of the present disclosure, there is no danger from the leakage of liquid metal. At these temperatures, these molten salt electrolytes are also not significantly corrosive.

In embodiments of the present disclosure, inorganic species are incorporated into the molten salts that have higher reduction potentials than the metal of the negative electrode. In these embodiments, the negative electrode of the electrochemical cell is protected with a layer solid electrolyte block or graft copolymer that has been doped with a salt of the negative electrode metal. Even though those species with higher reduction potentials would ordinarily electroplate in preference to the metal of the negative electrode, they are blocked from doing so by the layer of solid electrolyte copolymer, which preferentially transports dopant metal cation.

For such embodiments, the layer of ion-selective solid electrolyte block or graft copolymer allows the use of low T. inorganic molten salt electrolytes that include ionic species with a higher reduction potential than that of the metal ion released during discharge from the negative electrode. When metal batteries are constructed according to embodiments of the present disclosure with such copolymer coated negative electrodes and with a low T. inorganic molten salt electrolyte between the copolymer and the positive electrode, the facile ion transport through liquid-like channels of the copolymer at the negative electrode, and the ability of the molten salt electrolyte to penetrate the pores of the positive electrode, provide a high energy density, low impedance barrier battery, with a significantly improved cycle life, reduced threat of dendrite formation, and enhanced safety profile. The ability of the copolymer coating to adjust to volume changes and to self-heal if damaged reduces the detrimental effects of such volume changes during cycling, further enhancing battery life.

Bi-electrolyte batteries with a more electropositive metal at the negative electrode and a more electronegative metal at the positive electrode can make use of cheap and abundant materials, e.g. sodium and iron, in contrast to batteries that use more expensive intercalation-type materials. Use of a second metal is further advantageous compared to intercalation materials, since the latter suffer from decrepitation, which leads to capacity fade. However, without an ion-selective barrier, the composition of inorganic molten salt electrolytes that can be used for such bimetallic batteries is limited to salts of metals that are more cathodic (electropositive) than the negative electrode metal. But because a metallic positive electrode must be less cathodic than the negative electrode metal, any metal ions released during charging from the positive electrode would preferentially plate onto the negative electrode, making such a cell suitable only for operation as a primary cell. However, with an ion-selective barrier, the cell can be recharged by plating the negative electrode metal. In the presence of such an ion-selective barrier, a broader range of inorganic molten salt compositions can be used, allowing for an assortment of positive electrode metals, and better control over the melting point of the inorganic molten salt.

### Polymer

The present disclosure provides a negative electrode of a lithium metal electrochemical cell with a layer of conformable polymer that provides lithium ion selectivity.

In some embodiments, the conformable polymer comprises a block or graft copolymer. In some embodiments, a block or graft copolymer may be incorporated as an ion-selective conformable polymer solid-state electrolyte. According to some such embodiments, the block or graft copolymer has one or more “A” segments of more hydrophilic polymers capable of solvating electropositive metal salts, interspersed with one or more “B” segments of more hydrophobic polymers. All segments are above their respective glass transition temperatures, T_{g}. Material comprising such a block or graft copolymer microphase separates into locally segregated nanoscale domains of “A” and “B” segments. The resultant ordering of segments in turn confers conformational rigidity to the material even though all of the constituents are segmentally liquid. For suitable A:B ratios, the A segments form continuous lithium ion solvating channels. For lithium ion solvating chains having suitably high local chain mobility, high lithium conductivity allows the directed flow of lithium ions through the copolymer upon application of an electric field. In some embodiments, doping the copolymer with a lithium salt ensures a high selectivity for lithium cations.

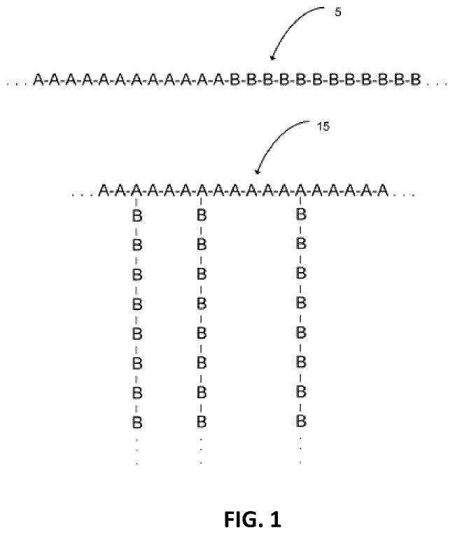

As illustrated in FIG. 1, block copolymers 5 disclosed herein comprise alternating blocks of monomer units, here designated by type “A” and type “B” monomers. In some embodiments, graft copolymers 15 have a backbone made up of type “A” monomers and side-chains of type “B” monomers. The block copolymer 5 of FIG. 1 is a di-block polymer (AB) with one block of A and one block of B. In other embodiments, block copolymers can be tri-block (ABA or BAB) or multi-block copolymers.

Block copolymers with blocks of immiscible groups and graft copolymers with immiscible backbone and side-chain segments as described in the present disclosure comprise conformable polymers. In some embodiments, conformable polymers provide a solid electrolyte with the ion transport properties of a liquid and with the ability to preferentially transport desired ionic species, while blocking the transport of undesirable species. In some embodiments, the solid electrolyte has low flammability and a resistance to dendrite formation. In some embodiments, the solid electrolyte has the mechanical properties of a solid but can undergo molecular rearrangements to grow, to shrink, and to accommodate volume changes associated with positive and negative electrodes while still maintaining physical contact with both positive and negative electrodes.

In some embodiments, conformable polymers in the form of block copolymers with blocks of immiscible groups and graft copolymers with immiscible backbone and side-chain segments provide a solid electrolyte technology for lithium metal batteries in general and Li-S batteries in particular with improved safety and performance, longer battery life, and a solution to the “polysulfide shuttle” problem. In some embodiments, block copolymers and graft copolymers provide the key features of an ideal solid electrolyte for lithium metal batteries.

In some embodiments, a block or graft copolymer comprises one or more “A” segments of lithium salt solvating polymers interspersed with one or more “B” segments. All segments may be above their respective glass transition temperatures, T_{g}. Material incorporating such a block or graft copolymer microphase separates into locally segregated nanoscale domains of “A” and “B” segments. The resultant ordering of segments in turn confers conformational rigidity to the material even though all of the constituents are segmentally liquid. For suitable A:B ratios, the A segments form continuous lithium ion solvating channels. For lithium ion solvating chains having suitably high local chain mobility, high lithium conductivity allows the directed flow of lithium ions through the copolymer upon application of an electric field.

Dissolving the block or graft copolymer in a suitable common solvent (cosolvent) that is capable of dissolving both A and B segments allows ready processing of the polymer by conventional coating methods. In some embodiments, electrodes may be directly coated with block or graft copolymer electrolyte by dipping the electrode in a solution of copolymer with cosolvent, and allowing the cosolvent to evaporate. Such an electrode may then be directly used in a battery or electrolytic cell. In some embodiments, as described below, lithium metal electrodes may be coated with lithium ion conducting block or graft copolymer solid electrolytes for use in solid state batteries.

In some embodiments, suitable copolymers comprise di-block copolymers (AB), tri-block copolymers (ABA or BAB), or higher multiblock polymers with alternating A and B blocks. All blocks may be above their respective glass transition temperatures, T_{g}. Likewise suitable are graft copolymers with backbone A monomers and side-chain B monomers, or back-bone B monomers and side-chain A monomers. In some embodiments, the A segments incorporate short poly(oxyethylene)ₙ side chains, where n, the number of oxyethylene groups in the side chain ranges from 4 to 20. In some embodiments, n ranges from 7 to 11. In some embodiments, n is equal to nine. In some embodiments, the poly(oxyethylene)ₙ side chains are incorporated by polymerization of poly(oxyethylene)ₙ methacrylate monomers. In some embodiment, the A segments are synthesized by polymerization of poly(oxyethylene)₉ methacrylate monomers.

In some embodiments, the B segments comprise alkyl side chains having from 4 to 12 carbons. In some embodiments, the B segments are synthesized from a poly(alkyl methacrylate). In some embodiments, the poly(alkyl methacrylate) is chosen from the group consisting of poly(butyl methacrylate), poly(hexyl methacrylate), and poly(laurel methacrylate). In some embodiment, the poly(alkyl methacrylate) is poly(laurel methacrylate).

In some embodiments, the “A” segments incorporate a mixture of neutral and anionic groups. In some embodiments, the anionic groups are configured to minimize coordination of the anionic groups with lithium cations.

In some embodiment, the copolymer comprises the di-block copolymer poly[(oxyethylene)₉ methacrylate]-b-poly(laurel methacrylate)(POEM-b-PLMA).

In some embodiments, the block copolymers are synthesized by living anionic polymerization. In some embodiments, the block copolymers are synthesized by atom transfer radical polymerization (ATRP).

In some embodiments, the conformable polymer comprises a graft copolymer with a backbone of “A” segments that are lithium salt solvating and “B” segments that phase separate from the “A” segments. Each segment may be above its respective glass transition temperature, T_{g}.

In some embodiment, the graft copolymer comprises backbone “A” segments incorporating short poly(oxyethylene)ₙ side chains, where n, the number of oxyethylene groups in the side chain ranges from 4 to 20. In some embodiments, n ranges from 7 to 11. In some embodiments, n is equal to nine. In some embodiments, the poly(oxyethylene)ₙ side chains are incorporated by polymerization of poly(oxyethylene)ₙ methacrylate monomers. In some embodiment, the A segments are synthesized by polymerization of poly(oxyethylene)₉ methacrylate monomers.

In some embodiments, the conformable polymer comprises a graft copolymer with side chain “B” segments incorporating poly(dimethyl siloxane)(PDMS). In some embodiment, the graft copolymer is incorporated into a poly(oxyethylene)ₙ methacrylate backbone by random copolymerization of poly(dimethyl siloxane) monomethacrylate macromonomer (PDMSMA) with poly(oxyethylene)n methacrylate monomers to form a graft copolymer of type POEM-g-PDMS. In some embodiments, poly(oxyethylene), methacrylate monomers are reacted to form the POEM-g-PDMS copolymer.

In some embodiments, the “A” backbone comprises additional monomers. In some embodiments, the additional monomers comprise anionic. In an embodiment, poly(oxyethylene)₉ methacrylate monomers are copolymerized with methacrylate monomers (MAA) and with PDMSMA to form poly(oxyethylene)₉-ran-MAA-g-PDMS. In some embodiment, the carboxylic acid groups of this polymer may be reacted with BF3 to give anionic boron trifluoride esters, which have a reduced tendency to complex lithium ions when compared with MAA carboxylate groups.

As illustrated in FIG. 1, block copolymers 5 of embodiments of the present disclosure have alternating blocks of monomer units, here designated by type “A” and type “B” monomers. In contrast graft copolymers 15 of embodiments of the present disclosure have a backbone made up of type “A” monomers and side-chains of type “B” monomers. The block copolymer 5 of FIG. 1 is a di-block polymer (AB) with one block of A and one block of B. In other embodiments, block copolymers can be tri-block (ABA or BAB) or multi-block copolymers.

Block copolymers with blocks of immiscible groups and graft copolymers with immiscible backbone and side-chain segments as embodied in this application provide a solid electrolyte with the ion transport properties of a liquid and with the ability to preferentially transport desired ionic species, while blocking the transport of undesirable species. The thus embodied solid electrolyte has low flammability and a resistance to dendrite formation. The thus embodied solid electrolyte is conformable, having the mechanical properties of a solid but being able to accommodate volume changes associated with negative electrodes while still maintaining physical contact with the electrode.

Consequently, block copolymers with blocks of immiscible groups and graft copolymers with immiscible backbone and side-chain segments as embodied in this application provide ion-selective, conformable polymer solid-state electrolytes with improved safety and performance, longer battery life, and resistance to dendrite formation. The use of such copolymers to protect the negative electrode of a rechargeable battery allows the use of low T. molten salt electrolytes.

A block or graft copolymer as embodied in this application has one or more “A” segments of more hydrophilic metal salt solvating polymers interspersed with one or more “B” segments of more hydrophobic polymers. All segments are above their respective glass transition temperatures, T_{g}. Material incorporating such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous, selective, metal ion solvating channels. For metal ion solvating chains having suitably high local chain mobility, high metal ion conductivity allows the selective, directed flow of metal ions through the copolymer upon application of an electric field.

Dissolving the block or graft copolymer in a suitable common solvent (cosolvent) that is capable of dissolving both A and B segments allows ready processing of the polymer by conventional coating methods. For example, electrodes can be directly coated with block or graft copolymer electrolyte by dipping the electrode in a solution formed by dissolving the copolymer and the salt of an electropositive metal in the cosolvent and allowing the cosolvent to evaporate. Such an electrode can then be directly used in a battery or in an electrolytic cell. In this manner, as described below, electropositive metal electrodes can be coated with elastomeric, electropositive metal ion-selective conducting block or graft copolymer solid electrolytes for use in rechargeable batteries according to embodiments of the present disclosure.

Suitable copolymers can be di-block copolymers (AB), tri-block copolymers (ABA or BAB), or higher multiblock polymers with alternating A and B blocks. All blocks are above their respective glass transition temperatures, T_{g}. Likewise suitable are graft copolymers with backbone A monomers and side-chain B monomers, or back-bone B monomers and side-chain A monomers. In some embodiments, the A segments incorporate short poly(oxyethylene)n side chains, where n, the number of oxyethylene groups in the side chain ranges from 4 to 20, preferably between 7 and 11. In some embodiments n is equal to nine. In some embodiments the poly(oxyethylene)n side chains are incorporated by polymerization of poly(oxyethylene)n methacrylate monomers. In a preferred embodiment, the A segments are synthesized by polymerization of poly(oxyethylene)9 methacrylate monomers.

In some embodiments, the B segments have alkyl side chains having from 4 to 12 carbons. In some embodiments, the B segments are synthesized from a poly(alkyl methacrylate). In some embodiments, the poly(alkyl methacrylate) is chosen from the group consisting of poly(butyl methacrylate), poly(hexyl methacrylate), and poly(laurel methacrylate). In a preferred embodiment, the poly(alkyl methacrylate) is poly(laurel methacrylate).

In some embodiments the “A” segments incorporate a mixture of neutral and anionic groups. In some such embodiments, the anionic groups are configured in order to minimize coordination of the anionic groups with metal cations.

In a preferred embodiment, the copolymer is the di-block copolymer poly[(oxyethylene)₉ methacrylate]-b-poly(laurel methacrylate) (POEM-b-PLMA).

In some embodiments, the block copolymers are synthesized by living anionic polymerization. In some embodiments, the block copolymers are synthesized by atom transfer radical polymerization (ATRP).

In some embodiments, the copolymer is a graft copolymer with a hydrophilic backbone of “A” segments that are metal salt solvating and hydrophobic side-chains of “B” segments made up of hydrophobic polymers. Each segment is above its respective glass transition temperature, T_{g}.

In a preferred embodiment, the copolymer is a graft copolymer with backbone “A” segments incorporating short poly(oxyethylene)n side chains, where n, the number of oxyethylene groups in the side chain ranges from 4 to 20, preferably between 7 and 11. In some embodiments, n is equal to nine. In some embodiments, the poly(oxyethylene)ₙ side chains are incorporated by polymerization of poly(oxyethylene)n methacrylate monomers. In a preferred embodiment, the A segments are synthesized by polymerization of poly(oxyethylene)₉ methacrylate monomers.

In some embodiments, the conformable polymer is a graft copolymer with side chain “B” segments incorporating poly(dimethyl siloxane) (PDMS). In a preferred embodiment, the graft copolymer is incorporated into a poly(oxyethylene)n methacrylate backbone by random copolymerization of poly(dimethyl siloxane) monomethacrylate macromonomer (PDMSMA) with poly(oxyethylene)n methacrylate monomers to form a graft copolymer of type POEM-g-PDMS. In preferred embodiments, poly(oxyethylene), methacrylate monomers are reacted to form the POEM-g-PDMS copolymer.

In some embodiments, the “A” backbone includes additional monomers. In some embodiments the additional monomers are anionic. In an embodiment, poly(oxyethylene) methacrylate monomers are copolymerized with methacrylate monomers (MAA) and with PDMSMA to form poly(oxyethylene)9-ran-MAA-g-PDMS. In an embodiment, the carboxylic acid groups of this polymer are reacted with BF3 to give anionic boron trifluoride esters, which have a reduced tendency to complex metal ions when compared with MAA carboxylate groups.

### Rechargeable Battery

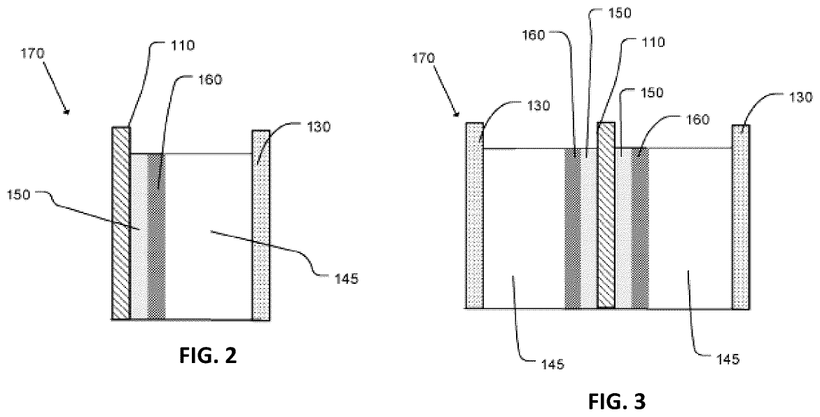

In the rechargeable battery 170 embodied in FIG. 2, the negative electrode is provided by a conductive substrate 110, which is coated with a layer of lithium metal 150. The layer of lithium metal 150 is sandwiched between the conductive substrate 110 on a first side and a conformable polymer solid electrolyte 160 on a second side. On the opposite side of the conformable polymer solid electrolyte 160 is a single positive electrode 130. Juxtaposed between the conformable polymer solid electrolyte and the single positive electrode, and physically contacting both is an inorganic molten salt electrolyte 145. The single positive electrode 130 is wetted with the inorganic molten salt electrolyte 145. In some embodiments, the positive electrode 130 is porous and infiltrated with the inorganic molten salt electrolyte.

In the rechargeable battery 175 embodied in FIG. 3, a single negative electrode comprises a conductive substrate 110 and a layer of lithium metal 150 coated on all sides of the conductive substrate. The lithium metal 150 is in turn sandwiched between a layer of conformable polymer solid electrolyte 160. Two positive electrodes 130 are provided at opposite sides of the cell, with each being separated from the conformable polymer solid electrolyte 160 by inorganic molten salt electrolyte, the inorganic molten salt electrolyte 145 physically contacting the conformable polymer solid electrolyte 160. The two positive electrodes 130 are wetted by the inorganic molten salt electrolyte 145. In some embodiments, the positive electrode 130 is porous and infiltrated with the inorganic molten salt electrolyte 14.

In some embodiments of the batteries of FIGS. 2 and 3, a lithium salt is dispersed within the conformable polymer. In some embodiments, the lithium salt comprises LiCF₃SO₃. In some embodiments, the conformable polymer comprises a block or graft copolymer with ethylene oxide segments. In some such embodiments, LiCF₃SO₃ is dispersed within the block or graft copolymer at a molar ratio of from 50:1 to 10:1 ethylene oxide to lithium ion. In some embodiment, the LiCF₃SO₃ is dispersed within the block or graft copolymer at a molar ratio of 20:1 ethylene oxide to lithium ion. In some embodiments, the block or graft copolymer with dispersed lithium salt coating the negative electrode is formed by solution casting directly from anhydrous tetrahydrofuran (THF).

In some embodiments, the positive electrodes of the rechargeable batteries of FIGS. 2 and 3 comprise intercalative lattice structures of transition metal compounds capable of incorporating Li⁺. In some embodiments, the positive electrodes comprise materials chosen from the group consisting of layered structures, spinel phase transition metal oxides, olivine phase transition metal phosphates, nickel-manganese-cobalt (NMC) and nickel-cobalt-aluminum (NCA) structures. In some embodiments, the layered structures have the formula LiMO₂, wherein M comprises Fe, Mn, Ni, or Co. In some embodiments, the spinel phase transition metal oxides have the formula LiM₂O₄, wherein M comprises Ni or Mn. In some embodiments, the olivine transition metal phosphates have the formula LiMPO₄, wherein M comprises Fe, Mn, or Co.

In some embodiments, the rechargeable batteries of FIGS. 2 and 3 comprise lithium-chalcogen batteries, for which the positive electrode comprises elemental chalcogen chosen from the group consisting of sulfur, selenium, tellurium, and combinations thereof. In some embodiments, the batteries may be Li-S batteries, for which the positive electrode comprises elemental sulfur. In some embodiments, the chalcogen in the positive electrode is associated with a conductive matrix, enabling suitably high electron conductivity.

Li-S batteries constructed in the manner of FIGS. 2 and 3 enable Li⁺ transport, but block the transport of anions, including in particular polysulfide anions. Consequently, the polysulfide shuttle responsible for reducing the performance and cycle life of Li-S batteries may be vitiated.

In embodiments of the batteries of FIGS. 2 and 3, the inorganic molten salt has a melting point (Tₘ) less than 140° C. In some embodiments, the inorganic molten salt 145 has a Tₘ less than 100° C. In some embodiments, the inorganic molten salt 145 has a Tₘ less than 75° C. In some embodiments, the inorganic molten salt 145 has a Tₘ less than 50° C. In some embodiments, the inorganic molten salt 145 has a Tₘ less than 30° C. In some embodiments, the inorganic molten salt 145 has a Tₘ less than 150, 140, 130, 120, 110, 100, 90, 80, 70, 60, 50, 40, 30, or 20° C. In some embodiments, the inorganic molten salt 145 has a Tₘ less than about 150, 140, 130, 120, 110, 100, 90, 80, 70, 60, 50, 40, 30, or 20° C.

In some embodiments, the inorganic molten salt comprises aluminum salts. In some embodiments, the molar percentage of aluminum salts is at least 50%. In some embodiments, the molar percentage of aluminum salts is 50, 55, 60, 65, 70, 75, 80, 85, or 90%. In some embodiments, the molar percentage of aluminum salts is about 50, 55, 60, 65, 70, 75, 80, 85, or 90%. In some embodiments, the aluminum salts comprise aluminum chloride. In some embodiments, the inorganic molten salt electrolyte comprises anions chosen from the group consisting of halides, including chlorides, bromides, and iodides.

The batteries as embodied in FIGS. 2 and 3 are non-combustible and have long cycle lives. Because the batteries in FIGS. 2 and 3 operate at low temperature, only modest amounts of energy may be required to melt the salts to form the inorganic molten salt electrolyte. Consequently, only a modest input of initial energy allows the battery to become operational. In an electric vehicle, such energy may, for example, be supplied by a conventional lead acid car battery of the type required to start an internal combustion engine. Once operational, the salts may remain in the molten state due to resistance heating. Consequently, computational control of charging and recharging may not be required, in contrast to conventional lithium ion batteries, which depend on such computational control during charging processes in order to prevent overheating and combustion.

The inorganic molten salts have excellent ionic conductivity, and generally provide little impedance at the interface with the positive electrode. Because of the presence of the lithium-salt doped conformable polymer coating, inorganic molten salt electrolytes may comprise cations having a greater reduction potential than that of lithium metal. Such cations may be blocked from reaching the negative electrode surface by the conformable polymer coating, and may thus not compete with lithium ion for reduction at that surface. In some embodiments, the coating inhibits dendrite formation, further enhancing the cycle life of the battery. In some embodiments, the conformable polymer coating rejects other non-lithium ionic impurities, comprising polysulfides associated with the polysulfide shuttle. Consequently, lithium sulfur batteries according to embodiments of the present disclosure do not suffer performance degradation over multiple cycles.

The combination of low Tₘ inorganic molten salt electrolytes and conformable polymer architecture disclosed herein may provide batteries that are safe, efficient, have long cycle lives, and require minimal energy for startup.

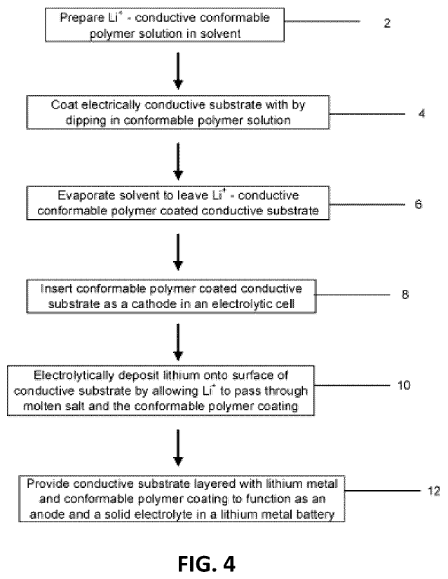

With reference to FIG. 4, in some embodiments, a conformable polymer coated lithium metal electrode may be manufactured and inserted along with a positive electrode into a rechargeable cell to form a lithium metal battery, with the lithium metal electrode providing a negative electrode and the conformable polymer providing a solid electrolyte. In some such embodiments, the conformable polymer may be a block or graft copolymer.

With reference to FIG. 4, in some embodiments, steps for producing a lithium metal electrode comprise: as a first step, a solution of the lithium ion conductive conformable polymer may be prepared in a solvent. For some embodiments, the conformable polymer may be a block or graft copolymer and the solvent may be a cosolvent capable of dissolving both A and B segments 2. In a second step, an electrically conductive substrate may be coated with the conformable polymer by dipping the substrate in the conformable polymer solution 4. As a third step, the solvent may be evaporated and leave the electrolytically conductive substrate coated with conformable polymer 6. In a next step, the conformable polymer-coated conductive substrate may be inserted as a cathode in an electrolytic cell. The electrolytic cell comprises an anode providing a source of lithium and an inorganic molten salt electrolyte 8. Then, voltage may be applied across the anode and the substrate, acting as a cathode, causing electrons to flow from the anode through an external circuit to the conductive substrate, causing lithium ions to be pulled from the anode through the inorganic molten salt electrolyte, and further to be selectively pulled through the conformable polymer coating, to be reduced at the substrate surface, thereby electrolytically plating lithium metal onto the surface 10. As lithium metal plates, the polymer chains of the conformable polymer coating may undergo a molecular rearrangement, allowing the coating to continue to cover the growing layer of lithium metal, resulting in a final product for which the substrate is coated with a layer of lithium metal, and the layer of lithium metal is in turn coated with a layer of conformable polymer solid electrolyte. In the final step, the conductive substrate layered with lithium metal and a conformable polymer solid electrolyte may be inserted as the combined lithium metal negative electrode and solid electrolyte in a lithium metal battery 12.

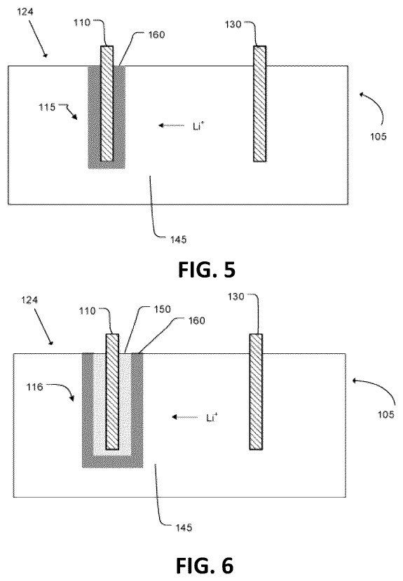

FIGS. 5 and 6 describe an electrolytic cell 124 suitable for the production of a lithium metal electrode according to the process of FIG. 4. A conductive substrate 110 that has been coated with conformable polymer 160 may be inserted as the cathode of an electrolytic cell, and immersed into a inorganic molten salt electrolyte 145 juxtaposed between the conformable polymer and an anode 130 at the opposite end of the cell 124. The anode 130 may provide a source of lithium ions, and may be a lithium metal electrode or lithium ion electrode from a recycled lithium battery. As shown in FIG. 6, as the cell operates, an external voltage causes electrons to move from the anode 130 to the conductive substrate. Lithium ions released from the anode traverse the inorganic molten salt, selectively move through the conformable polymer 160, and combine with electrons on the surface of the conductive substrate 110 to electroplate lithium metal 150 on the surface of the conductive substrate 110. As this process occurs, the conformable polymer coating 160 may undergo molecular rearrangements that allow it to adjust to volume changes and coat the growing layer of lithium metal 150. In this manner, a conformable polymer coated lithium metal electrode may be obtained that can be used to make a lithium metal battery.

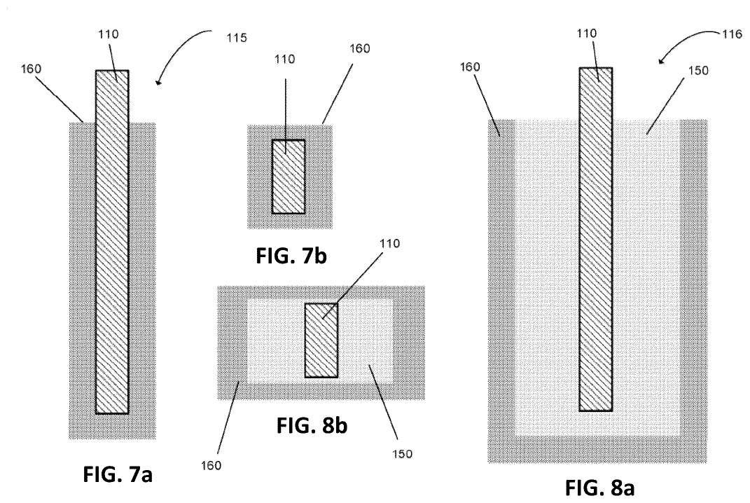

FIG. 7a shows a cross-section and FIG. 7b shows a top view of a conformable polymer coated electrically conductive substrate 110 according to embodiments of the present disclosure. Following the process of dipping the electrically conductive substrate 110 into a conformable polymer solution and drying, the centrally located electrically conductive substrate 110 may be surrounded by a layer of conformable polymer solid electrolyte 160. FIG. 8a shows a cross-section and FIG. 8b shows a top view of the conformable polymer coated lithium metal electrode that can be obtained following the electrolytic plating onto the electrically conductive substrate 110 of a layer of lithium metal 150 which fills the space between the conductive substrate 110 and the conformable polymer solid electrolyte 160.

The method of FIG. 4, as embodied in FIGS. 5 and 6, may allow for the efficient and selective plating of lithium metal in the presence of ions of more noble metallic species and thereby allows for the recovery of lithium from impure sources of lithium metal and the efficient recycling of lithium metal from lithium ion and lithium metal batteries.

In the rechargeable battery 170 embodied in FIG. 2, the negative electrode is provided by a conductive substrate 110, which is coated with a layer of electropositive metal 150. Exemplary electropositive metals include lithium, sodium, magnesium, and aluminum. The layer of electropositive metal 150 is sandwiched between the conductive substrate 110 on a first side and an elastomeric SSE 160 on a second side. Opposite the elastomeric SSE 160 is a single positive electrode 130. Juxtaposed between the elastomeric SSE and the single positive electrode, and physically contacting both is a molten salt electrolyte 145. The positive electrode is constructed from a metal that is less electropositive than the metal of the negative electrode. Exemplary materials for the positive electrode include bismuth, lead, zinc, tin, and iron. The molten salt electrolyte 145 necessarily contains ions of the metals in the negative and positive electrodes.

In the rechargeable battery 175 embodied in FIG. 3, a single negative electrode includes a conductive substrate 110, the conductive substrate coated on all sides with a layer of electropositive metal 150. Exemplary electropositive metals include lithium, sodium, magnesium, and aluminum. The electropositive metal 150 is in turn sandwiched between a layer of elastomeric SSE 160. Two positive electrodes 130 are provided at opposite sides of the cell, with each being separated from the elastomeric SSE 160 by molten salt electrolyte, the molten salt electrolyte 145 physically contacting the elastomeric SSE 160. The positive electrodes are constructed from a metal that is less electropositive than the metal of the negative electrode.

Exemplary materials for the positive electrode include bismuth, lead, zinc, tin, and iron. The molten salt electrolyte 145 necessarily contains ions of the metals in the negative and positive electrodes.

In preferred embodiments of the batteries of FIGS. 2 and 3, the elastomeric SSE is a copolymer solid electrolyte and a salt of the electropositive metal is dispersed within the copolymer. In some embodiments, the salt is the metal triflate, e.g., LiCF₃SO₃, NaCF₃SO₃, Mg(CF₃SO₃)₂, or Al(CF₃SO₃)₃. In some embodiments the salt is dispersed within the copolymer at a molar ratio of between 50:1 and 10:1 ethylene oxide to metal ion. In a preferred embodiment, the salt is dispersed within the copolymer at a molar ratio of 20:1 ethylene oxide to metal ion. In some embodiments, the copolymer with dispersed salt coating the negative electrode is formed by solution casting directly from anhydrous tetrahydrofuran (THF).

In embodiments of the batteries of FIGS. 2 and 3, the molten salt has a melting point (Tₘ) less than 140° C. In some embodiments, the molten salt 145 has a Tₘ less than 100° C. In some embodiments, the molten salt 145 has a Tₘ less than 75° C. In some embodiments, the molten salt 145 has a Tₘ less than 50° C. In some embodiments, the molten salt 145 has a Tₘ less than 30° C.

In some embodiments, the molten salt includes aluminum salts, wherein the molar percentage of aluminum salts is at least 50%. In some embodiments, the aluminum salts include aluminum chloride. In some embodiments, the mixture of inorganic salts includes anions chosen from the group consisting of halides, including chlorides, bromides, and iodides and mixtures of them, e.g., AlBrC₁₂.

The batteries as embodied in FIGS. 2 and 3 are non-combustible and have long cycle lives. Because the batteries in FIGS. 2 and 3 operate at low temperature, only modest amounts of energy are required to melt the salts to form the molten salt electrolyte. Consequently, only a modest input of initial energy allows the battery to become operational. In an electric vehicle, such energy may, for example, be supplied by a conventional lead acid car battery of the type required to start an internal combustion engine. Once operational, the salts remain in the molten state due to resistance heating as current is passing.

The molten salts have excellent ionic conductivity and generally encounter little impedance at the interface with the positive electrode. Because of the presence of the copolymer membrane doped with a salt of the electropositive metal, molten salt electrolytes can include cations having a greater reduction potential (more anodic) than that of the electropositive metal. Such cations will be blocked from reaching the negative electrode surface by the elastomeric SSE and will thus not compete with electropositive ion for reduction at that surface. Moreover, the elastomeric SSE inhibits dendrite formation, further enhancing the cycle life of the battery.

In summary, the combination of low T. molten salt electrolytes and elastomeric SSE architecture of the present disclosure provides batteries as embodied in FIGS. 2 and 3 that are safe, efficient, have long cycle lives, and require minimal energy for startup. As summarized by the manufacturing steps shown in FIG. 4, in some embodiments a copolymer coated electropositive metal electrode is manufactured and inserted along with a positive electrode, itself a metal that undergoes an exchange reaction with the molten salt, into a rechargeable cell to form a metal displacement battery, with the electropositive metal electrode providing a negative electrode and the copolymer providing an elastomeric SSE.

The steps of this embodiment are as follows: first, prepare the selective electropositive ion conductive block or graft copolymer solution by dissolving the block or graft copolymer with a metal salt of the electropositive metal of the negative electrode in a cosolvent capable of dissolving both A and B segments 2. For example, a sodium-ion selective block or graft copolymer solution can be prepared by dissolving the copolymer with sodium triflate (NaCF₃SO₃) in tetrahydrofuran (THF). Similarly, a lithium, magnesium, or aluminum selective block or graft copolymer can be prepared by dissolving the copolymer with the triflate salts of lithium, magnesium, or aluminum, respectively. Second, coat an electrically conductive substrate with the selective electropositive ion-conductive copolymer by dipping the substrate in the copolymer solution 4. Third, evaporate the cosolvent to leave the ionically conductive substrate coated with copolymer 6. Next, insert the copolymer-coated conductive substrate as a cathode in an electrolytic cell, the electrolytic cell including an anode, the anode providing a source of electropositive metal, and a molten salt electrolyte 8. Then, apply voltage across the anode and the substrate, acting as a cathode, causing electrons to flow from the anode through an external circuit to the conductive substrate, causing electropositive ions to be pulled from the anode through the molten salt electrolyte, and further to be selectively pulled through the copolymer coating, to be reduced at the substrate surface, thereby electrolytically plating electropositive metal onto the surface 10. As the electropositive metal plates, the copolymer coating adjusts to continue to cover the growing layer of electropositive metal, resulting in a final product for which the substrate is coated with a layer of electropositive metal, and the layer of electropositive metal is in turn coated with a layer of copolymer solid electrolyte. In the final step, the conductive substrate layered with electropositive metal and the copolymer solid electrolyte is inserted as the combined electropositive metal negative electrode and solid electrolyte in an electropositive metal battery 12.

FIGS. 5 and 6 embody an electrolytic cell 124 suitable for the production of an electropositive metal electrode according to the process of FIG. 4. A conductive substrate 110 that has been coated with elastomeric SSE 160 is inserted as the cathode of an electrolytic cell and immersed into a molten salt electrolyte 145 juxtaposed between the elastomeric SSE 160 and an anode 130 at the opposite end of the cell 124. The anode 130 provides a source of ions (M1 of the electropositive metal and can, for example, be a metal electrode or an intercalated ion electrode from a recycled battery. As shown in FIG. 6, as the cell operates, an external voltage causes electrons to move from the anode 130 to the conductive substrate. Electropositive ions released from the anode traverse the molten salt, selectively move through the copolymer 160, and combine with electrons on the surface of the conductive substrate 110 to electroplate electropositive metal 150 on the surface of the conductive substrate 110. As this process occurs, the copolymer coating 160 adjusts to volume changes and continues to coat the growing layer of electropositive metal 150. In this manner, a copolymer coated electropositive metal electrode is obtained that can be used to make an electropositive metal battery.

FIG. 7a shows a cross-section and FIG. 7b shows a top view of a copolymer coated electrically conductive substrate 110 according to embodiments of the present disclosure. Following the process of dipping the electrically conductive substrate 110 into a cosolvent solution of copolymer and drying, the centrally located electrically conductive substrate 110 is surrounded by a layer of elastomeric SSE 160. FIG. 8a shows a cross-section and FIG. 8b shows a top view of the elastomeric SSE coated electropositive metal electrode that can be obtained following the electrolytic plating onto the electrically conductive substrate 110 of a layer of electropositive metal 150 which fills the space between the conductive substrate 110 and the elastomeric SSE 160.

The method of FIG. 4, as embodied in FIGS. 5 and 6, allows for the efficient and selective plating of electropositive metal in the presence of ions of more noble metallic species and thereby allows for the recovery of electropositive metal from impure sources of electropositive metal and the efficient recycling of electropositive metal from, for example, lithium ion and lithium metal batteries.

### Transition Metal Extraction

In certain aspects, the present disclosure relates to the cost-effective and environmentally benign recovery of transition metals from battery scrap comprising rechargeable lithium battery electrodes.

Borate and pyrophosphate glasses form melts at modest temperatures (below 1100° C.), and when these melts comprise one or both of Na₂O and NaF, they can dissolve relatively large amounts of certain transition metal oxides. As an added benefit, the addition of Na₂O and NaF reduces the viscosity of melts of borate and pyrophosphate glasses. Grigorenko has shown that zirconium oxide dissolves in melts of borate and pyrophosphate glasses and can be electrolytically plated from such melts. (F. F. Grigorenko and L. I. Savrans'kii, “Electrochemical investigation of zirconium dioxide in fluoride-borate melts,” Visn. Kiivs'k. Univ. Ser. Astron., Fiz. to Khim., Vol. 1, No. 5, 136-139 (1962); F. F. Grigorenko and B. I. Danil'tsev, “Solubility of zirconium dioxide in molten sodium diphosphate,” Visnyk Kyivs'k. Univ., Ser. Khim., Vol. 8, 73-76 (1967)). In this work, Grigorenko found that ZrO₂ solubility was enhanced for both borate melts and pyrophosphate melts by the presence of NaF. Amietszajew examined the solubility of nickel oxide, cobalt oxide, and manganese oxide in borate melts and found enhanced solubility in the presence of Na₂O. (T. Amietszajew, S. Seetharaman and R. Bhagat, “The solubility of specific metal oxides in molten borate glass,” J. Am. Ceram. Soc., Vol 98, 2984-2987 (2015)).

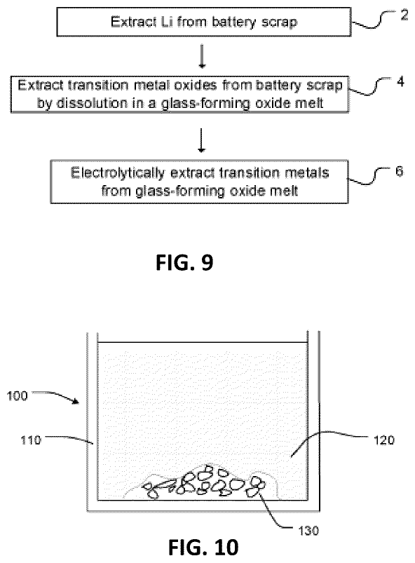

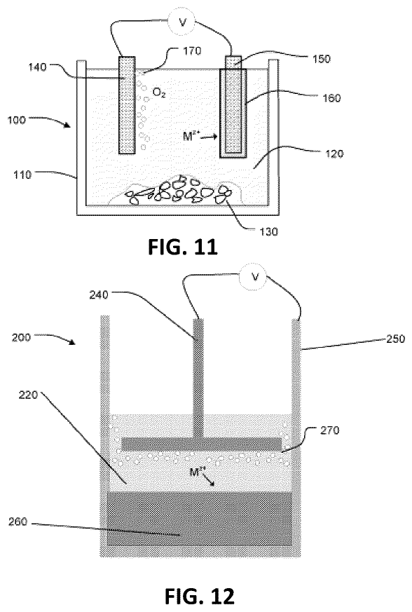

As embodied in FIG. 9, a general method of recycling lithium battery scrap is embodied in FIG. 9. An optional first step is to extract lithium from the battery scrap 2, leaving lithium depleted battery scrap. Next, the battery scrap, optionally depleted of lithium, is immersed in a glass-forming oxide melt, and one or more transition metal oxides present in the lithium battery scrap are dissolved into the melt 4. Electrodes are then disposed in the melt and the one or more transition metals are extracted by electrolysis 6. Two distinct electrolytic methods of extracting the one or more transition metals from the melt are embodied in FIGS. 11 and 12-14, respectively.

As embodied in FIG. 10, battery scrap 130, optionally depleted of lithium, is placed in a dissolution chamber 100 with insulating walls 110. The battery scrap 130 is dispersed in a glass-forming oxide melt 120, contained within the insulating walls 110, and kept at a temperature between about 600° C. and about 1100° C. In a preferred embodiment, the battery scrap 130 is continuously mixed with the glass-forming oxide melt 120 within the dissolution chamber 100.

In some embodiments, the glass-forming oxide melt 120 is maintained at a temperature of between 600° C. and 1100° C. In some embodiments, the glass-forming oxide melt 120 is maintained at a temperature of between 600° C. and 700° C. In some embodiments, the glass-forming oxide melt 120 is maintained at a temperature of between 700° C. and 800° C. In some embodiments, the glass-forming oxide melt 120 is maintained at a temperature of between 800°C. and 900° C. In some embodiments, the glass-forming oxide melt 120 is maintained at a temperature of between 900° C. and 1000° C. In some embodiments, the glass-forming oxide melt 120 is maintained at a temperature of between 1000° C. and 1100° C.

After sufficient time is allowed for dissolution of the one or more transition metal oxides, controlled electrolytic extraction allows recovery of the one or more transition metals from the glass-forming oxide melt. A first method of electrolytic recovery is embodied in FIG. 11. A second method is embodied in FIGS. 12-14.

According to the method embodied in FIG. 11, the glass-forming oxide melt 120 with dissolved transition metal oxide is maintained at a temperature of between 600° C. and 1100° C. An anode 140 and an electrically conducting substrate 150 configured as a cathode are disposed within the glass-forming oxide melt 120. Voltage applied across the anode 140 and the electrically conducting substrate 150 results in electroplating of transition metal 160 onto the electrically conducting substrate 150 and the generation of oxygen gas 170 at the anode 140.

Electroplating of transition metals from the glass-forming oxide melt will occur in order of increasing reduction potential for the transition metal oxides in the glass-forming oxide melt 120. While generally, as voltage is applied, less electropositive (more noble) metals will plate first, followed by more electropositive transition metals, other factors, including the solvation free energy of the dissolved metal oxide in the glass-forming oxide melt 120, may influence the reduction potential, and thus the order of electroplating.

In a preferred embodiment, monitored changes in electrical properties signal the depletion of a first dissolved metal oxide from the oxide melt 120, and the end of electroplating of the transition metal 160 of that first transition metal oxide. In this embodiment, when the first transition metal 160 is plated, as judged by monitored changes in electrical properties, a first electrically conductive substrate 150 onto which plating has occurred, is removed from the oxide melt, allowing for recovery of the first plated transition metal 160.

In some embodiments, at this point a second electrically conductive substrate 150 is disposed in the electrolytic cell, and connected as the cathode of the cell. Voltage continues to be applied until monitored changes in electrical properties indicate that a second transition metal 160 has plated onto the second electrically conductive substrate 150, at which point the second electrically conductive substrate 150, is removed from the cell for recovery of the electroplated second transition metal 160.

In further embodiments, successive transition metals are electroplated onto successive electrically conductive substrates 150, allowing for their removal and recovery.

In preferred embodiments, a large change or discontinuity in electrical properties provides the signal that a transition metal has electroplated. A variety of electrical properties can provide such a signal, including any or all of current, voltage, time derivatives of current, time derivatives of voltage, and combinations thereof.

In a preferred embodiment, voltage is adjusted to maintain constant current, and a jump in voltage at constant current signals the depletion of one metal oxide from the glass-forming oxide melt 120, and the completion of electroplating of the metal associated with that metal oxide onto a conductive substrate 150.

In preferred embodiments, voltage can continue to be applied to remove successive transition metals in the order of increasing reduction potential, until all transition metals that are initially present as transition metal oxides in the lithium battery scrap are depleted from the glass-forming oxide melt 120, and reduced to metallic form.

In some embodiments, the lithium battery scrap has been pre-sorted to include only lithium cobalt oxide (LCO) batteries. For such batteries, the only transition metal oxides present are cobalt oxides, and electroplating according to the method embodied in FIG. 11 will result in the electroplating of cobalt onto a single conductive substrate.

In some embodiments, the lithium battery scrap will include lithium nickel manganese cobalt (NMC) batteries with mixed oxides of nickel, manganese, and cobalt. For such lithium battery scrap, application of the method of FIG. 11 will result in successive electroplating of cobalt, nickel and manganese onto electrically conductive substrates in the order from the highest (least cathodic) to the lowest (most cathodic) reduction potential. Due to its highly electropositive nature, manganese will always plate last, but the order of cobalt and nickel electroplating may vary depending on the experimental parameters and the composition of the glass-forming oxide.

According to the method embodied in FIGS. 12-14, transition metals are extracted from the glass-forming oxide melt 120 with dissolved transition metal oxide according to a two-step process. In the first step, embodied in FIG. 12, an extraction cell 200 is configured with a liquid metal cathode 260 disposed at the bottom of the cell. The liquid metal cathode 260 contacts an electrically conductive substrate 250. Glass-forming oxide melt 220 is disposed on top the liquid metal cathode 260. An anode 240 is disposed within the glass-forming oxide melt. The electrolytic cell 200 is maintained at a temperature of between 600° C. and 1100° C. Voltage applied across the anode 240 and the electrically conducting substrate 250 results in the reduction of any transition metal oxides to metallic transition metal at the liquid metal cathode 260 and the generation of oxygen gas 270 at the anode 240. The reduced transition metals form a liquid metal alloy with the liquid metal of the cathode 260.

In some embodiments, the liquid metal cathode 260 is predominantly tin. In some embodiments, the liquid metal cathode 260 is predominantly bismuth. In some embodiments, the liquid metal cathode 260 is an alloy composed predominantly of tin and bismuth. In preferred embodiments, the melting point of the liquid metal cathode 260 is less than 300° C.

In some embodiments, the transition metal oxides initially present in the battery scrap include oxides of cobalt, nickel, and manganese. For such embodiments, following the first step of the process embodied in FIG. 12, the liquid metal alloy includes elemental cobalt, nickel, and manganese.

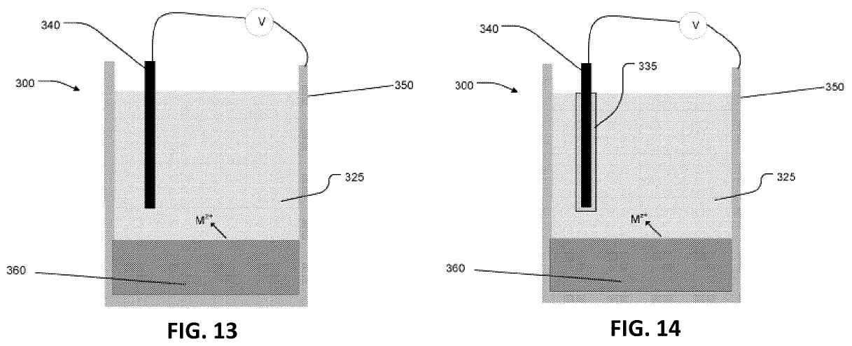

The second step of the method is embodied in FIGS. 13 and 14. According to this step, the liquid metal alloy is now configured as an anode 360 in a refiner cell 300. Resting atop the liquid metal alloy anode 360 is a molten salt electrolyte 325, comprising salts of metals that are more electropositive than the transition metals present in the liquid metal alloy. As embodied in FIG. 13, an electrically conductive, inert substrate is configured as a cathode 340 in the molten salt electrolyte 325. According to this embodiment, the operating temperature of the refiner cell 300 is greater than the melting temperature of the molten salt electrolyte 325 and of the liquid metal alloy anode 360 but less than the melting temperature of the one or more transition metals present in the liquid metal alloy anode 360.

As embodied in FIG. 14, the application of voltage and passage of current across the cathode 340 and the liquid metal anode 360 by means of an electrically conductive anode connector 350 causes a layer of transition metal 335 to electroplate on the cathode. Because the transition metals with the highest reduction potential are the first to oxidize, they will also be the first to electroplate, and transition metals will electroplate onto the cathode 340 in order of decreasing reduction potential in the molten salt system.

In a preferred embodiment, following electroplating of a first transition metal, the cathode 340 is removed from solution to collect the pure metal form of the first transition metal. In some embodiments, a new cathode 340 is then configured in the refiner cell 300, and a second transition metal is electroplated. Once the second transition metal is electroplated and the cathode 340 with layer of transition metal is removed, then another cathode 340 may be inserted to collect the third transition metal, and the process of electroplating, removing cathode for collection, and electroplating is continued until all transition metals initially present in the liquid metal anode 360 are extracted.

In preferred embodiments, in order to determine when a given transition metal is completely electroplated, electrical properties can be monitored, with suitable electrical properties including current, voltage, time derivatives of current, time derivatives of voltage, and combinations thereof. In some embodiments, voltage can be monitored at constant current, and an abrupt change in voltage will signal completion of electroplating of the given transition metal.

In some embodiments, the transition metal with the highest (least cathodic) reduction potential is manganese, the second highest reduction potential is cobalt, and the third highest reduction potential is nickel, and the cathodes in the refining cell are electroplated in the order manganese, cobalt, and nickel.

In some embodiments, the molten salt electrolyte 325 includes a combination of one or more halide salts of alkali cations, alkaline earth cations, and NH₄⁺. In preferred embodiments, the molten salt electrolyte 325 includes one or more of LiCl, NaCl, KCl, NH₄Cl , MgCl₂, CaCl₂, SrCl₂, and BaCl₂.

In some embodiments, the lithium battery scrap 130 is presorted to separate cathodes and anodes, and only the cathode-containing scrap is used to recover transition metals.

In some embodiments, the glass forming oxide melt is predominantly B₂O₃. In some embodiments, the melt is predominantly pyrophosphate. In some embodiments the melt includes one or more of Na₂O and NaF. In a preferred embodiment, the melt is predominantly B₂O₃, and the molar ratio of B₂O₃ to Na₂O is greater than about 2:1.

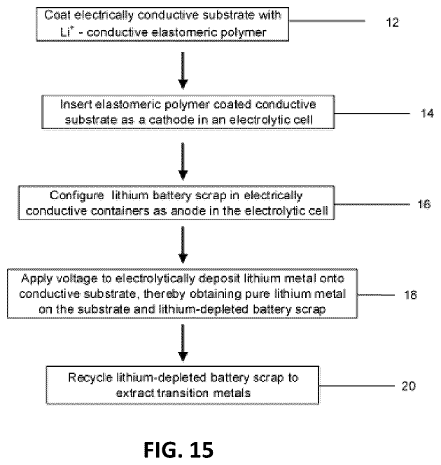

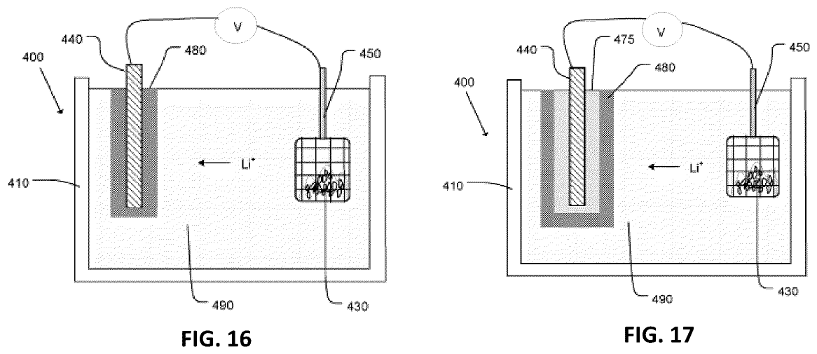

In some embodiments, the battery scrap from which transition metal is extracted is first depleted of lithium. In some embodiments, the lithium is depleted electrolytically. In some embodiments the lithium is stripped electrolytically by the procedure set forth in FIG. 15, using the electrolytic cell embodied in FIGS. 16 and 17. Details of electrolytic processes suitable for this procedure are described in Appendices A and B.

According to the method of FIG. 15, an electrically conductive substrate is coated with an elastomeric polymer that is selectively conductive of lithium ion. 12. The elastomeric polymer coated electrically conductive substrate is then configured as a cathode in an electrolytic cell. 14. Lithium battery scrap in electrolyte-permeable electrically conductive containers is configured as an anode in the electrolytic cell. 16. Upon application of voltage, lithium metal is electrolytically deposited onto a conductive substrate, thereby obtaining both pure lithium metal on the substrate and lithium-depleted battery scrap. 18. The lithium-depleted battery scrap then provides the substrate for the extraction of transition metals by processes such as those embodied in FIGS. 9 through 14. 20.

An electrolytic cell 400 for performing the method of FIG. 15 is shown in FIGS. 16 and 17. The cell includes a cell wall 410. Disposed within the cell wall 410 are a lithium-ion selective elastomeric polymer coated electrically conductive substrate 440, configured as a cathode, an electrolyte 490, and an electrically conductive basket 450, immersed in the electrolyte 490, and containing lithium battery scrap 430, the electrically conductive basket 450 being permeable to the electrolyte 490, and allowing immersion of the battery scrap 430 in the electrolyte. The electrically conductive basket 450, together with the lithium battery scrap 430 are configured as an anode in the electrolytic cell 400.

As embodied in FIG. 17, as voltage is applied across the electrically conductive substrate 440, and the electrically conductive basket 450 containing lithium battery scrap 430, lithium ions flow through the electrolyte solution and selectively electroplate on the electrically conductive substrate 440, forming a layer of lithium metal 475, and depleting the lithium battery scrap 430 of lithium.

Upon depletion of lithium, the lithium battery scrap 430 provides lithium-depleted battery scrap suitable for transition metal extraction according to above-described embodiments.

The treatment of battery scrap to remove lithium, as embodied in FIGS. 15-17, followed by the extraction of transition metals as embodied in FIG. 9-14, provide a complete recycling solution for lithium batteries.

### Modulation of Electroplated Surface Features

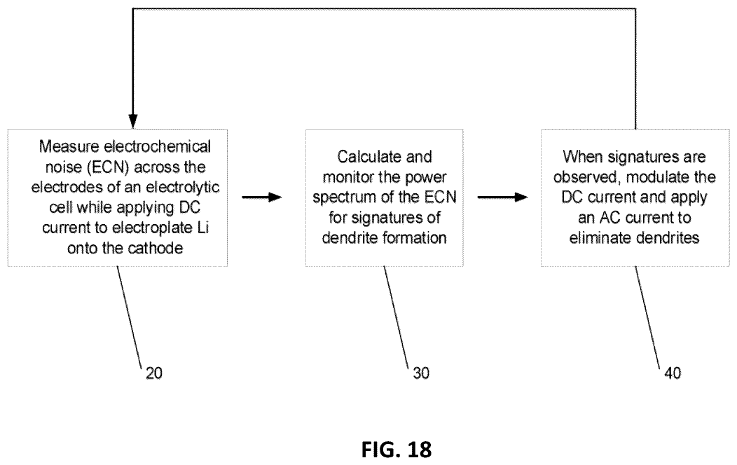

An embodiment of the method of the present disclosure is provided in FIG. 18. Electrochemical noise is measured as dc voltage is applied to electroplate lithium. 20. A power spectrum is calculated from the noise and monitored for signatures of dendrite formation. 30. When signatures of dendrite formation are observed, the de current is modulated and/or an alternating current is applied across the electrodes to eliminate dendrites. 40. The electrochemical noise is then monitored again 20 and the process 30, 40 repeated as the cell is charged, thereby eliminating dendrites as they form.

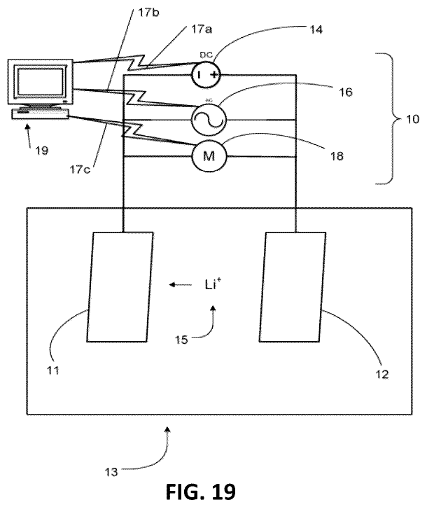

FIG. 19 provides an embodiment of a system 10 for monitoring and controlling the electrolytic deposition of metal for an electrolytic cell 13 according to the present disclosure. A direct current (dc) power supply 14 provides a dc voltage across a negative electrode 11 and a positive electrode 12 of the electrolytic cell 13. The de charging current provides electrons to the negative electrode 11 and withdraws electrons from the positive electrode 12. During this process, lithium ions 15 migrate towards the negative electrode 11, and combine with the electrons to form lithium metal, which is electrodeposited on the negative electrode 11. Also connected across the positive electrode 12 and the negative electrode 11 are an alternating current (ac) voltage source 16 and an electrochemical noise monitor 18. The dc power supply 14, the ac voltage source 16 and the electrochemical noise monitor 18 are each communicably coupled 17a, 17b, 17c, respectively, to a controller 19.

The electrochemical noise monitor 18 measures the voltage as a function of time across the electrodes, and sends an output signal proportional to that voltage to the controller 19. After subtracting the mean value of the signal, the controller 19 divides the time dependent noise signal into time domain windows and, in each window subjects the remaining noise fluctuation signal to fast Fourier transform, thereby providing a series of voltage versus frequency signals (power spectra) for each successive time domain window. In a preferred embodiment, the time domain window is between 1 to 20 seconds. In a preferred embodiment, the time domain window ranges from 5 seconds to 10 seconds. The controller 19 monitors the successive power spectra for characteristic frequency signatures of dendrite formation. When the power spectra show such dendrite signatures, the controller sends a first control signal to the dc power supply 14 and a second control signal to the ac voltage source 16. The first control signal directs the dc power supply to change magnitude and/or direction in order to reverse dendrite formation. The second control signal directs the ac voltage source to provide an appropriate ac current in order to reverse dendrite formation.

In some embodiments, in the absence of dendrite formation the decay of correlation of the noise is exponential and the power spectra are Lorentzian line-shapes. Deviations from Lorentzian behavior provide the characteristic signatures of dendrite formation and other electrochemical phenomena. Such deviations may include peaks at specific frequencies. In a particular embodiment, peaks at between 0.05 and 0.2 Hz provide characteristic signatures of dendrite formation.

In a preferred embodiment, the second control signal directs the ac voltage source to input ac power with absolute magnitude that is no greater than 10% of the magnitude of the dc power. In a preferred embodiment, the input ac voltages are provided at the dendrite signature frequencies of the power spectrum.

In some embodiments, the first control signal directs the de voltage source to temporarily reverse polarity, thereby preferentially removing electroplated dendrites.

In some embodiments, a constant ac ripple current is applied during electrodeposition, and as dendrite signatures appear in the spectral density, the ac ripple current is modulated by additional ac frequencies in order to vitiate dendrite formation.

In some aspects, the present disclosure provides a method of electrodepositing lithium. In some embodiments, the method comprises providing an electrochemical cell comprising a negative electrode, a positive electrode, an electrolyte, and lithium ions. In some embodiments, the method comprises electrodepositing lithium ions as lithium metal onto the negative electrode by applying an electrical potential or current between the negative electrode and the positive electrode. In some embodiments, the electrodepositing is performed while monitoring electrochemical noise of the electrochemical cell. In some embodiments, the electrodepositing is performed while monitoring electrochemical impedance of the electrochemical cell. In some embodiments, the electrical potential or current is modulated based on the electrochemical noise.

In some embodiments, the electrochemical cell is within a rechargeable lithium metal battery. In some embodiments, the negative electrode is a lithium metal electrode a lithium metal battery.

In some embodiments, the electrical potential is applied with a substantially constant electrical potential or current, e.g., direct current (DC). In some embodiments, the electrical potential is applied with a fluctuating electrical potential or current, e.g., alternating current (AC). In some embodiments, the electrical potential is applied as a combination of (i) a constant electrical potential or current and (ii) an alternating electrical potential or current.

In some embodiments, the alternating electrical potential or current is modulated based on the electrochemical noise. In some embodiments, the alternating electrical potential or current is modulated based on the electrochemical impedance. In some embodiments, the alternating electrical potential or current is modulated in real-time based on the electrochemical noise. In some embodiments, the alternating electrical potential or current is modulated in real-time based on the electrochemical impedance. In some embodiments, the electrical potential or current is modulated based on the electrochemical noise when the electrochemical noise provides a signature of dendrite formation in the lithium metal. In some embodiments, the electrical potential or current is modulated based on the electrochemical impedance when the electrochemical impedance provides a signature of dendrite formation in the lithium metal. In some embodiments, the electrical potential or current is modulated in frequency, phase, amplitude, or wave shape based on the electrochemical noise. In some embodiments, the electrical potential or current is modulated in frequency, phase, amplitude, or wave shape based on the electrochemical impedance. In some embodiments, the signature of dendrite formation is a spectral signature. In some embodiments, the spectral signature is detected in real-time. In some embodiments, the spectral signature is detected in a power spectrum of the electrochemical noise. In some embodiments, the spectral signature is detected in a Fourier transform of the electrochemical noise. In some embodiments, the spectral signature is detected in a Laplace transform of the electrochemical noise. In some embodiments, the spectral signature is detected in a power spectrum of the electrochemical impedance. In some embodiments, the spectral signature is detected in a Fourier transform of the electrochemical impedance. In some embodiments, the spectral signature is detected in a Laplace transform of the electrochemical impedance. In some embodiments, the electrical potential or current is modulated to eliminate dendrites. In some embodiments, the electrical potential or current is modulated to reduce the formation of dendrites.

In some embodiments, the monitoring and the modulating can be performed using a device or apparatus comprising computer-executable instructions configured to, autonomously or in real-time, (i) monitor for the spectral signature, (ii) modulate the electrical potential or current when the spectral signature is detected.

### LIST OF EMBODIMENTS

The following list of embodiments of the invention is to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.
1. A rechargeable lithium metal battery comprising:
   a negative electrode, the negative electrode having a conductive substrate coated with a layer of lithium metal, the layer of lithium metal having an inner face and an outer face, the inner face contacting the conductive substrate;
   a positive electrode;
   a solid electrolyte comprising a lithium ion conductive conformable polymer coating the outer face of the lithium metal;
      a lithium salt dispersed within the solid electrolyte; and
   an inorganic molten salt electrolyte, wherein the melting temperature of the inorganic molten salt electrolyte is less than 140° C.,
      wherein the inorganic molten salt electrolyte is disposed between the solid electrolyte and the positive electrode, and is in direct physical contact with both the solid electrolyte and the cathode.
2. The rechargeable lithium metal battery of embodiment 1, wherein the lithium ion conductive conformable polymer is a graft or block copolymer with first segments and second segments, each segment above its respective glass transition temperature, T_{g}, the first segment formed from lithium ion solvating groups and the second segment being immiscible with the first segment, wherein the lithium ion conductive copolymer forms microphase separated first domains and second domains, the first domains formed from the first segments and providing continuous conductive pathways for the transport of lithium ions and the second domains formed from the second segments.
3. The rechargeable lithium metal battery of embodiment 1, wherein the inorganic molten salt electrolyte includes at least one ionic species having a lower or more cathodic reduction potential than Li⁺.
4. The rechargeable lithium metal battery of embodiment 1, wherein the inorganic molten salt electrolyte includes one or more salts selected from the group consisting of, alkali metal salts, alkaline earth metal salts, ammonium salts, and combinations thereof.
6. The rechargeable lithium metal battery of embodiment 1, wherein the inorganic molten salt electrolyte includes anions chosen from the group consisting of halides, nitrates, nitrites, sulfates, sulfites, carbonates, hydroxides and combinations thereof.
8. The rechargeable lithium metal battery of embodiment 1, wherein the positive electrode comprises elemental sulfur.
9. The rechargeable lithium metal battery of embodiment 2, wherein the lithium ion solvating chains comprise poly(oxyethylene)n side chains, where n is an integer between 4 and 20.
10. The rechargeable lithium metal battery of embodiment 1, wherein the positive electrode is porous and infiltrated by the inorganic molten salt electrolyte.
11. The rechargeable lithium metal battery of embodiment 2, wherein the copolymer is a block copolymer.
12. The rechargeable lithium metal battery of embodiment 2, wherein the copolymer is a graft copolymer.
13. The rechargeable lithium metal battery of embodiment 2, wherein the second segments comprise poly(alkyl methacrylate).
14. The rechargeable lithium metal battery of embodiment 2, wherein the second segments comprise poly(dimethyl siloxane).
15. The rechargeable lithium metal battery of embodiment 11, wherein the lithium ion conductive copolymer is poly[(oxyethylene)₉ methacrylate]-b-poly(laurel methacrylate) (POEM-b-PLMA).
16. The rechargeable lithium metal battery of embodiment 12, wherein the lithium ion conductive copolymer is poly[(oxyethylene)₉ methacrylate]-g-poly(dimethyl siloxane).
17. The rechargeable lithium metal battery of embodiment 15, wherein the ratio of POEM to PLMA is between 55:45 and 70:30 on a molar basis.
18. The rechargeable lithium metal battery of embodiment 1, wherein the melting temperature of the inorganic molten salt electrolyte is less than 100° C.
19. The rechargeable lithium metal battery of embodiment 1, wherein the melting temperature of the inorganic molten salt electrolyte is less than 75° C.
20. The rechargeable lithium metal battery of embodiment 1, wherein the melting temperature of the inorganic molten salt electrolyte is less than 50° C.
21. The rechargeable lithium metal battery of embodiment 1, wherein the melting temperature of the inorganic molten salt electrolyte is less than 30° C.
22. A process for manufacturing a lithium metal electrode comprising:
configuring a lithium ion conductive conformable polymer coated conductive substrate as a cathode in an electrolytic cell;
configuring a lithium ion source as an anode for the electrolytic cell;
disposing an inorganic molten salt electrolyte between the solid electrolyte and the anode, so that the inorganic molten salt electrolyte is in direct physical contact with both the lithium ion conductive conformable polymer and the anode,
   wherein the melting temperature of the inorganic molten salt electrolyte is less than 140° C., and wherein the inorganic molten salt electrolyte includes at least one ionic species having a lower or more cathodic reduction potential than Li⁺;
applying a voltage across the anode and the conductive substrate, thereby depositing a layer of lithium metal on the surface of the conductive substrate, sandwiched between the conductive substrate and the lithium ion conductive conformable polymer coating.
23. The process for manufacturing the lithium metal electrode according to embodiment 22, wherein the lithium ion conductive conformable polymer is a graft or block copolymer with first segments and second segments, each segment above its respective glass transition temperature, T_{g}, the first segments formed from lithium ion solvating groups and the second segments being immiscible with the first segments,
wherein the block or graft copolymer forms microphase separated first domains and second domains, the first domains formed from the first segments and providing continuous conductive pathways for the transport of lithium ions and the second domains formed from the second segments.
24. The process for manufacturing the lithium metal electrode according to embodiment 23, wherein the block or graft copolymer coated conductive substrate is prepared by a method including:
   preparing a coating solution by dissolving the block or graft copolymer in a cosolvent, each segment of the lithium ion conductive copolymer being separately soluble in the cosolvent;
   coating a conductive substrate with the coating solution;
   evaporating the cosolvent from the coated conductive substrate so that the conductive substrate is coated with a layer of the block or graft copolymer.
25. The process according to embodiment 22, wherein the anode comprises an electrode from a recycled battery, the recycled battery being chosen from the group consisting of a lithium metal battery and a lithium ion battery.
26. A lithium metal electrode coated with lithium ion conductive conformable polymer manufactured according to the process of embodiment 22.
27. A lithium metal electrode coated with lithium ion conductive block or graft copolymer, manufactured according to the process of embodiment 23.
28. The rechargeable lithium metal battery of embodiment 2, wherein the second segments comprise poly(dimethyl siloxane).
29. The lithium metal electrode according to embodiment 27, wherein the lithium ion conductive conformable polymer is a graft copolymer.
30. The lithium metal electrode according to embodiment 27, wherein the first segments comprise poly(oxyethylene)n side chains, where n is an integer between 4 and 20.
31. The lithium metal electrode coated with a lithium ion conductive copolymer according to embodiment 28, wherein the second segments comprise poly(alkyl methacrylate).
32. The lithium metal electrode coated with lithium ion conductive conformable polymer according to embodiment 29, wherein the second segments comprise poly(dimethyl siloxane).
33. The lithium metal electrode coated with lithium ion conductive conformable polymer according to embodiment 28, the block copolymer being poly[(oxyethylene)₉ methacrylate]-b-poly(laurel methacrylate) (POEM-b-PLMA).
34. The lithium metal electrode coated with lithium ion conductive conformable polymer according to embodiment 29, the graft copolymer being poly[(oxyethylene)₉ methacrylate]-g-poly(dimethyl siloxane).
35. The lithium metal electrode coated with lithium ion conductive conformable polymer according to embodiment 33, wherein the ratio of POEM to PLMA is between 55:45 and 70:30 on a molar basis.
36. A rechargeable metal displacement battery comprising:
   a negative electrode, the negative electrode having a conductive substrate coated with a layer of a first metal, the layer of the first metal having an inner face and an outer face, the inner face contacting the conductive substrate;
   a positive electrode, the positive electrode comprising a second metal;
   a solid electrolyte comprising a conformable polymer that preferentially conducts ions of the first metal compared to ions of the second metal, and that coats the outer face of the layer of the first metal;
   a molten salt electrolyte, the molten salt electrolyte being a mixture of inorganic salts including a first salt of the first metal and a salt of the second metal, wherein the melting temperature of the molten salt electrolyte is less than 140° C.,
      wherein the molten salt electrolyte is disposed between the solid electrolyte and the positive electrode, and is in direct physical contact with both the solid electrolyte and the positive electrode, and
      wherein the first metal is more electropositive than the second metal.
37. The rechargeable metal displacement battery of embodiment 36, wherein the conformable polymer is a graft or block copolymer with a first segment and a second segment, each segment above its respective glass transition temperature, T_{g}, the first segment formed from groups configured to solvate a second salt of the first metal and the second segment being immiscible with the first segment, and wherein the second salt of the first metal is dispersed within the solid electrolyte.
38. The rechargeable metal displacement battery of embodiment 36, wherein the first metal is selected from the group consisting of an alkali metal, an alkaline earth metal, and aluminum.
39. The rechargeable metal displacement battery of embodiment 36, wherein the second metal is selected from the group consisting of Fe, Ni, Bi, Pb, Zn, Sn, and Cu.
40. The rechargeable metal displacement battery of embodiment 36, wherein the mixture of inorganic salts includes one or more salts selected from the group consisting of aluminum salts, titanium salts, iron salts, alkali metal salts, alkaline earth metal salts, ammonium salts, and combinations thereof.
41. The rechargeable metal displacement battery of embodiment 36, wherein the mixture of inorganic salts includes aluminum salts, and wherein the molar percentage of the aluminum salts is at least 50%.
42. The rechargeable metal displacement battery of embodiment 36, wherein the mixture of inorganic salts includes iron salts, and wherein the molar percentage of the iron salts is at least 50%.
43. The rechargeable metal displacement battery of embodiment 36, wherein the mixture of inorganic salts includes anions chosen from the group consisting of halides, nitrates, nitrites, sulfates, sulfites, carbonates, hydroxides, and combinations thereof.
44. The rechargeable metal displacement battery of embodiment 36, wherein the mixture of inorganic salts includes aluminum chloride, wherein the molar percentage of aluminum chloride is at least 50%.
45. The rechargeable metal displacement battery of embodiment 36, wherein the mixture of inorganic salts includes ferric chloride, wherein the molar percentage of ferric chloride is at least 50%.
46. The rechargeable metal displacement battery of embodiment 36, wherein the second metal is elemental aluminum, the first metal is elemental lithium, and the mixture of inorganic salts contains aluminum chloride, wherein the molar percentage of aluminum chloride is at least 50%.
47. The rechargeable metal displacement battery of embodiment 36, wherein the second metal is elemental iron, the first metal is elemental lithium, and the mixture of inorganic salts contains aluminum chloride (AlCl₃) and ferric chloride (AlCl₃), wherein the sum of the molar percentages of aluminum chloride and ferric chloride is at least 50%.
48. The rechargeable metal displacement battery of embodiment 36, wherein second metal is elemental iron, the first metal is elemental aluminum, and the mixture of inorganic salts contains aluminum chloride (AlCl₃) and ferric chloride (AlCl₃), wherein the sum of the molar percentages of aluminum chloride and ferric chloride is at least 50%.
49. The rechargeable metal displacement battery of embodiment 37, wherein the conformable polymer is a block copolymer.
50. The rechargeable metal displacement battery of embodiment 37, wherein the conformable polymer is a graft copolymer.
51. The rechargeable metal displacement battery of embodiment 37, wherein the first segments of the block or graft copolymer comprise poly(oxyethylene)n side chains, where n is an integer between 4 and 20.
52. The rechargeable metal displacement battery of embodiment 49, wherein the first segments of the block copolymer comprise poly(oxyethylene)n side chains, where n is an integer between 4 and 20, and the second segments of the block copolymer comprise poly(alkyl methacrylate).
53. The rechargeable metal displacement battery of embodiment 50, wherein the first segments of the graft copolymer comprise poly(oxyethylene)n side chains, where n is an integer between 4 and 20, and the second segments of the graft copolymer comprise poly(dimethyl siloxane).
54. The rechargeable metal displacement battery of embodiment 52, the block copolymer being poly[(oxyethylene)₉ methacrylate]-b-poly(laurel methacrylate) (POEM-b-PLMA).
55. The rechargeable metal displacement battery of embodiment 53, the graft copolymer being poly[(oxyethylene)₉ methacrylate]-g-poly(dimethyl siloxane).
56. The rechargeable metal displacement battery of embodiment 54, wherein the ratio of POEM to PLMA is between 55:45 and 70:30 on a molar basis.
57. The rechargeable metal displacement battery of embodiment 36, wherein the melting temperature of the molten salt electrolyte is less than 100° C.
58. The rechargeable metal displacement battery of embodiment 36, wherein the melting temperature of the molten salt electrolyte is less than 75° C.
59. The rechargeable metal displacement battery of embodiment 36, wherein the melting temperature of the molten salt electrolyte is less than 50° C.
60. The rechargeable metal displacement battery of embodiment 36, wherein the melting temperature of the molten salt electrolyte is less than 30° C.
61. A process for manufacturing an electropositive metal electrode comprising:
   providing a conformable polymer coated conductive substrate, the conformable polymer coated conductive substrate being configured to selectively transport ions of the electropositive metal;
   providing an anode for an electrolytic cell, the anode providing a source of the electropositive metal ions;
   configuring the conformable polymer coated conductive substrate as a cathode in the electrolytic cell, the electrolytic cell containing the anode, and a molten salt electrolyte comprising a mixture of inorganic salts, wherein the melting temperature of the molten salt electrolyte is less than 140° C., and wherein the mixture of inorganic salts includes at least one ionic species having a higher reduction potential than the electropositive metal ion;
      wherein the molten salt electrolyte is disposed between the conformable polymer and the anode, and is in direct physical contact with both the conformable polymer and the anode, interposed between the anode and the conformable polymer coated conductive substrate;
   applying a voltage across the anode and the conductive substrate, causing electrons to flow from the anode through an external circuit to the conductive substrate, and causing the electropositive metal ions to flow from the anode, through the molten salt electrolyte, through the conformable polymer coating, to the surface of the conductive substrate, to be reduced upon combining with the electrons, depositing a layer of the electropositive metal on the surface of the conductive substrate, sandwiched between the conductive substrate and the conformable polymer.
62. A process according to embodiment 61, wherein the conformable polymer is a block or graft copolymer with first segments and second segments, each segment above its respective glass transition temperature, T_{g}, the first segments formed from groups configured to solvate the electropositive metal ion and the second segment being immiscible with the first segments.
63. A process according to embodiment 62, wherein the conformable polymer coated conductive substrate is prepared by a method including:
   preparing a coating solution by dissolving the block or graft copolymer in a cosolvent, each segment of the block or graft copolymer being separately soluble in the cosolvent;
   coating a conductive substrate with the coating solution;
   evaporating the cosolvent from the coated conductive substrate so that the conductive substrate is coated with a layer of the block or graft copolymer.
64. A process according to embodiment 61, wherein the anode comprises an electrode from a recycled battery, the recycled battery being chosen from the group consisting of an electropositive metal battery and an electropositive metal-ion battery.
65. An electropositive metal electrode coated with electropositive metal ion-conductive copolymer manufactured according to the process of embodiment 62.
66. The electropositive metal electrode of embodiment 65, wherein the electropositive metal ion-conductive copolymer is a block copolymer.
67. The electropositive metal electrode coated with an electropositive metal ion-conductive copolymer according to embodiment 65, wherein the electropositive metal ion-conductive copolymer is a graft copolymer.
68. The electropositive metal electrode coated with an electropositive metal ion-conductive copolymer according to embodiment 65, wherein the first segments comprise poly(oxyethylene)n side chains, where n is an integer between 4 and 20.
69. The electropositive metal electrode coated with an electropositive metal ion-conductive block copolymer according to embodiment 66, wherein the second segments comprise poly(alkyl methacrylate).
70. The electropositive metal electrode coated with electropositive metal ion-conductive graft copolymer according to embodiment 67, wherein the second chains comprise poly(dimethyl siloxane).
71. The electropositive metal electrode coated with electropositive metal ion-conductive block copolymer according to embodiment 66, the electropositive metal ion-conductive copolymer being poly[(oxyethylene)₉ methacrylate]-b-poly(laurel methacrylate) (POEM-b-PLMA).
72. The electropositive metal electrode coated with electropositive metal ion-conductive graft copolymer according to embodiment 67, the electropositive metal ion-conductive copolymer being poly[(oxyethylene)₉ methacrylate]-g-poly(dimethyl siloxane).
73. The electropositive metal electrode coated with electropositive metal ion-conductive copolymer according to embodiment 72, wherein the ratio of POEM to PLMA is between 55:45 and 70:30 on a molar basis.
74. A process for recycling battery scrap containing one or more transition metal oxides comprising:
   submerging the battery scrap in a melt comprising a glass-forming oxide; holding the melt at a temperature between about 600° C. and about 1100° C., thereby allowing the one or more transition metal oxides to dissolve in the melt;
   disposing an anode and a first cathode in the melt; and
   applying a voltage across the anode and the first cathode, thereby generating oxygen at the anode and electroplating a first transition metal onto the first cathode.
75. The process for recycling battery scrap of embodiment 74, further comprising:
   monitoring electrical properties to determine when the first transition metal has been depleted from the melt, wherein the electrical properties monitored are selected from the group consisting of current, voltage, time derivatives of current, time derivatives of voltage, and combinations thereof; and
   removing the first cathode with first electroplated transition metal from the melt.
76. The process for recycling battery scrap of embodiment 75, further comprising: disposing a second cathode in the melt;
   applying a voltage across the anode and the second cathode, thereby generating oxygen at the anode and electroplating a second transition metal onto the second cathode;
   monitoring electrical properties to determine when the second transition metal has been depleted from the melt, wherein the electrical properties monitored are selected from the group consisting of current, voltage, time derivatives of current, time derivatives of voltage, and combinations thereof; and
   removing the second cathode with second electroplated transition metal from the melt.
77. The process for recycling battery scrap of embodiment 76, further comprising:
   continuing to apply voltage, electroplating successive transition metals on additional cathodes based on monitoring of electrical properties to determine depletion of successive transition metal, and removing successive cathodes with successive electroplated transition metals from the melt, wherein the electrical properties monitored are selected from the group consisting of current, voltage, time derivatives of current, time derivatives of voltage, and combinations thereof.
78. The process for recycling battery scrap of embodiment 74, wherein the voltage is applied in order to maintain a constant current.
79. The process for recycling battery scrap of embodiment 78, further comprising: continuing to apply voltage to maintain a constant current until a rise in voltage indicates depletion of the first transition metal oxide from the melt; and removing the first cathode with first electroplated transition metal from the melt.
80. A process for recycling battery scrap containing one or more transition metal oxides comprising:
   submerging the battery scrap in a melt comprising a glass-forming oxide, the melt being contained in an extraction cell;
   holding the melt at a temperature between about 600° C. and about 1100° C., thereby allowing the oxides of the one or more transition metals to dissolve in the melt;
   configuring a liquid metal cathode in the melt, the liquid metal cathode comprising liquid metal at the temperature of the melt;
   configuring an anode in the melt;
   applying a voltage across the anode and the liquid metal cathode, thereby generating oxygen at the anode and reducing the one or more transition metals at the liquid metal cathode, the reduced transition metals forming a liquid metal alloy with the liquid metal in the liquid metal cathode; and
   processing the liquid metal alloy to extract the one or more transition metals from the liquid metal alloy.
81. The process for recycling battery scrap containing one or more transition metal oxides of embodiment 80, wherein processing the liquid metal alloy to extract the one or more transition metals comprises the refining steps of:
   pooling the liquid metal alloy containing the one or more transition metals at the bottom of a refiner cell, the refiner cell further having a molten salt covering the pooled liquid metal alloy, wherein the liquid metal alloy is electrically configured as an anode in the refiner cell, wherein the melting temperature of the molten salt electrolyte is less than 300° C., and wherein the operating temperature of the refiner cell is greater than the melting temperature of the molten salt electrolyte and of the liquid metal alloy but less than the melting temperatures of the one or more transition metals that are present in the liquid metal alloy;
   configuring a first electrically conductive substrate to function as a first refiner cell cathode; and
   passing a current across the first electrically conductive substrate and the liquid metal alloy, causing a first transition metal to electroplate onto the first electrically conductive substrate.
82. The process for recycling battery scrap containing one or more transition metal oxides of embodiment 81, further comprising the steps of:
   monitoring electrical properties to determine when the first transition metal has been depleted from the molten salt electrolyte; and
   removing the first electrically conductive substrate coated with the first transition metal in order to recover the first transition metal in pure form,
   wherein the electrical properties monitored are selected from the group consisting of current, voltage, time derivatives of current, time derivatives of voltage, and combinations thereof.
83. The process for recycling battery scrap containing one or more transition metal oxides of embodiment 82, further comprising the steps of:
configuring a second electrically conductive substrate to function as a second refiner cell cathode; and
   passing a current across the second electrically conductive substrate and the liquid metal alloy, causing a second transition metal to electroplate onto the second electrically conductive substrate.
84. The process for recycling battery scrap containing one or more transition metal oxides of embodiment 83, further comprising the steps of:
   monitoring electrical properties to determine when the second transition metal has been depleted from the molten salt electrolyte; and
   removing the second electrically conductive substrate coated with the second transition metal in order to recover the second transition metal in pure form,
   wherein the electrical properties monitored are selected from the group consisting of current, voltage, time derivatives of current, time derivatives of voltage, and combinations thereof.
85. The process for recycling battery scrap containing one or more transition metal oxides of embodiment 84, further comprising the steps of:
   configuring successive electrically conductive substrates to function as successive refiner cell cathodes;
   passing a current across successive electrically conductive substrates and the liquid metal alloy, causing successive transition metals to electroplate onto successive electrically conductive substrates;
   monitoring electrical properties to determine when the successive transition metals have been depleted from the molten salt electrolyte; and
   removing successive electrically conductive substrates coated with successive transition metals in order to recover successive transition metals in pure form,
   wherein the electrical properties monitored are selected from the group consisting of current, voltage, time derivatives of current, time derivatives of voltage, and combinations thereof.
86. The process for recycling battery scrap containing one or more transition metal oxides of embodiment 74, wherein the glass-forming oxide is selected from the group consisting of borate, pyrophosphate, silicate, and combinations thereof 87. The process for recycling battery scrap containing one or more transition metal oxides of embodiment 74, wherein the melt further comprises Na2O.
88. The process for recycling battery scrap containing one or more transition metal oxides of embodiment 74, wherein the melt further comprises NaF.
89. The process for recycling battery scrap containing one or more transition metal oxides of embodiment 74, wherein the glass-forming oxide comprises borate.
90. The process for recycling battery scrap containing one or more transition metal oxides of embodiment 74, wherein the glass-forming oxide comprises pyrophosphate.
91. The process for recycling battery scrap containing one or more transition metal oxides of embodiment 74 wherein the transition metal forming the transition metal oxide is selected from the group consisting of cobalt, nickel, manganese, and combinations thereof.
92. The process for recycling battery scrap containing one or more transition metal oxides of embodiment 74, wherein the battery scrap comprises material from lithium batteries.
93. The process for recycling battery scrap containing one or more transition metal oxides of embodiment 74, wherein the battery scrap comprises lithium depleted battery scrap.
94. A process for obtaining lithium metal and lithium depleted battery scrap from battery scrap containing lithium in ionic or metallic form comprising:
   configuring the battery scrap as an anode in an electrolytic cell;
   configuring an electrically conductive substrate as a cathode in the electrolytic cell, the electrically conductive substrate being coated with a lithium ion selective elastomeric polymer;
   disposing a molten salt electrolyte in the electrolytic cell, such that the anode and the elastomeric polymer coated electrically conductive substrate are submerged in the molten salt electrolyte, wherein the melting temperature of the molten salt electrolyte is less than 140° C.; and
   applying a voltage across the anode and the electrically conductive substrate, the voltage causing a layer of lithium metal to deposit on the surface of the electrically conductive substrate, with the layer of lithium metal being sandwiched between the electrically conductive substrate and the elastomeric polymer coating, thereby providing the lithium metal in a form suitable for further processing, and the lithium depleted battery scrap.
95. A process for recycling lithium battery scrap containing one or more transition metal oxides, the process comprising:
   configuring the battery scrap as a first anode in an electrolytic cell;
   configuring an electrically conductive substrate as a first cathode in the electrolytic cell, the electrically conductive substrate being coated with a lithium ion selective elastomeric polymer;
   disposing a first molten salt electrolyte in the electrolytic cell;
   applying a voltage across the anode and the electrically conductive substrate, the voltage causing a layer of lithium metal to deposit on the surface of the electrically conductive substrate, with the layer of lithium metal being sandwiched between the electrically conductive substrate and the elastomeric polymer coating, thereby providing the lithium metal in a form suitable for further processing, and lithium depleted battery scrap;
   removing the lithium depleted battery scrap from the first molten salt electrolyte;
   submerging the lithium depleted battery scrap in a melt comprising a glass-forming oxide, the melt being contained in an extraction cell;
holding the melt at a temperature that allows the oxides of the one or more transition metals to dissolve in the melt;
configuring a second cathode in the melt;
configuring a second anode in the melt; and
applying a voltage across the second anode and the second cathode, thereby generating oxygen at the second anode and reducing the one or more transition metals at the second cathode for recovery.
96. A system configured for monitoring and controlling electrolytic deposition of metal in an electrolytic cell, the electrolytic cell including a positive electrode, a negative electrode, and an electrolyte providing a source of metal ions for electrodeposition onto the negative electrode, the system comprising:
   a variable direct current (dc) voltage source configured to receive a first control signal, and to provide a dc voltage across the positive electrode and the negative electrode based on the first control signal;
   a variable alternating current source configured to receive a second control signal, and to provide alternating current across the positive electrode and the negative electrode based on the second control signal;
   an electrochemical noise monitor configured to monitor current and voltage across the positive electrode and the negative electrode and to produce an output signal indicative of the current and voltage noise across the positive electrode and the negative electrode;
   an analysis and control system configured to receive the output signal, and to analyze the output signal to calculate a power spectrum of the noise, and further configured to output the first control signal to the variable dc voltage source, and the second control signal to the variable alternating current source, the first control signal and the second control signal being determined based on user-determined input parameters and on the power spectrum of the noise,
   wherein the system is configured such that, during operation, the de voltage and the alternating current control the surface features of the metal electrodeposited on the negative electrode based on the first control signal and the second control signal, respectively.
97. The system according to embodiment 96, the first control signal determining the magnitude and direction of the dc voltage.
98. The system according to embodiment 96, the second control signal determining the 10 magnitude and frequency of the alternating current.
99. The system according to embodiment 96, wherein the metal electrodeposited on the negative electrode comprises lithium.
100. The system according to embodiment 96, wherein the electrolytic cell is a rechargeable lithium metal battery.
101. The system according to embodiment 96, wherein, during operation, the dc voltage and the alternating current are controlled by the first control signal and the second control signal in order to reduce dendrite formation.
102. The system according to embodiment 101, wherein, during operation, the dc voltage is reversed in order to reduce dendrite formation.
103. The system according to embodiment 101, wherein, during operation, the alternating current is applied with frequency components corresponding to frequency components of the electrical noise in order to reduce dendrite formation.
104. The system according to embodiment 103, wherein, during operation, the dc voltage is set at zero during application of the alternating current.
105. The system according to embodiment 103, wherein, during operation the de voltage is reversed during application of the alternating current.
106. A method of monitoring and controlling electrolytic deposition of metal in an electrolytic cell comprising:
   providing an electrolytic cell,
      the electrolytic cell including:
         a positive electrode, a negative electrode, and an electrolyte providing a source of metal ions for electrodeposition onto the negative electrode;
            connecting a variable direct current (dc) voltage source across the positive electrode and the negative electrode of the electrolytic cell;
   connecting a variable alternating current source across the positive and the negative electrode;
   connecting an electrochemical noise monitor across the positive electrode and the negative electrode, the electrochemical noise monitor being configured to monitor current and voltage and to produce an output signal indicative of the current and voltage noise across the positive electrode and the negative electrode;
   providing an analysis and control system in communication with the dc voltage source, the alternating current source, and the electrochemical noise monitor; by means of the analysis and control system:
      receiving the output signal from the electrochemical noise monitor at the analysis and control system;
      calculating a power spectrum of the noise from the output signal;
      generating the first control signal to the variable de voltage source, and the second control signal to the variable alternating current source, the first control signal and the second control signal being determined based on user-determined input parameters and on the power spectrum of the noise,
   wherein, during operation, the dc voltage and the alternating current control the surface features of the metal electrodeposited on the negative electrode based on the first control signal and the second control signal, respectively.
107. The method according to embodiment 105, wherein the de voltage and the alternating current are controlled by the first control signal and the second control signal in order to reduce dendrite formation.
108. The method according to embodiment 107, wherein the dc voltage is reversed in order reduce dendrite formation.
109. The method according to embodiment 107, wherein the alternating current is applied with
   frequency components corresponding to frequency components of the electrical noise in order to reduce dendrite formation.
110. The method according to embodiment 109, wherein the dc voltage is set at zero during application of the alternating current.
111. The method according to embodiment 109, wherein the dc voltage is reversed during application of the alternating current.
112. A system configured for monitoring and controlling electrolytic deposition of metal in an electrolytic cell, the electrolytic cell including a positive electrode, a negative electrode, and an electrolyte providing a source of metal ions for electrodeposition onto the negative electrode, the system comprising:
   a voltage source configured to receive a control signal, and, based on the control signal, to provide a variable de voltage and a variable alternating current across the positive electrode and the negative electrode;
   an electrochemical noise monitor configured to monitor current and voltage across the positive electrode and the negative electrode and to produce an output signal indicative of the current and voltage noise across the positive electrode and the negative electrode;
   an analysis and control system configured to receive the output signal, and to analyze the output signal to calculate a power spectrum of the noise, and further configured to output the control signal to the voltage source, the control signal being determined based on user-determined input parameters and on the power spectrum of the noise,
   wherein the system is configured such that, during operation, the de voltage and the alternating current control the surface features of the metal electrodeposited on the negative electrode based on the control signal.
113. A method of monitoring and controlling electrolytic deposition of metal in an electrolytic cell comprising:
   providing an electrolytic cell,
      the electrolytic cell including:
         a positive electrode, a negative electrode, and an electrolyte providing a source of metal ions for electrodeposition onto the negative electrode;
   connecting a voltage source across the positive electrode and the negative electrode, the voltage source configured to provide a variable de voltage and a variable alternating current across the positive electrode and the negative electrode;
   connecting an electrochemical noise monitor across the positive electrode and the negative electrode, the electrochemical noise monitor being configured to monitor current and voltage and to produce an output signal indicative of the current and voltage noise across the positive electrode and the negative electrode;
   providing an analysis and control system in communication with the voltage source and the electrochemical noise monitor;
   by means of the analysis and control system:
      receiving the output signal from the electrochemical noise monitor at the analysis and control system;
      calculating a power spectrum of the noise from the output signal;
      generating the control signal to the voltage source, the control signal being determined based on user-determined input parameters and on the power spectrum of the noise,
   wherein, during operation, the direct current voltage and the alternating current control the surface features of the metal electrodeposited on the negative electrode based on the control signal.
114. The system according to embodiment 96, wherein the metal electrodeposited on the negative electrode comprises aluminum.
115. The system according to embodiment 96, wherein the electrolytic cell is a rechargeable aluminum metal battery.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1.-39. (canceled)

40. A rechargeable metal displacement battery comprising:
a negative electrode, wherein the negative electrode comprises a conductive substrate coated with a layer of a first metal having an inner face and an outer face, wherein the inner face is configured to contact the conductive substrate;
a positive electrode, wherein the positive electrode comprises a second metal;
a solid electrolyte comprising a conformable polymer that preferentially conducts ions of the first metal compared to ions of the second metal, and that coats the outer face of the layer of the first metal; and
a molten salt electrolyte, wherein the molten salt electrolyte is a mixture of inorganic salts comprising a first salt of the first metal and a salt of the second metal, wherein the melting temperature of the molten salt electrolyte is less than 140° C.,
wherein the molten salt electrolyte is disposed between the solid electrolyte and the positive electrode, and is in direct physical contact with both the solid electrolyte and the positive electrode, and
wherein the first metal is more electropositive than the second metal.

41. The rechargeable metal displacement battery of claim 40, wherein the conformable polymer is a graft or block copolymer with a first segment and a second segment, wherein each segment of the first and second segments is above its respective glass transition temperature, T_{g}, wherein the first segment is formed from groups configured to solvate a second salt of the first metal and the second segment is immiscible with the first segment, and wherein the second salt of the first metal is dispersed within the solid electrolyte.

42. The rechargeable metal displacement battery of claim 40, wherein the first metal is selected from the group consisting of an alkali metal, an alkaline earth metal, and aluminum.

43. The rechargeable metal displacement battery of claim 40, wherein the second metal is selected from the group consisting of Fe, Ni, Bi, Pb, Zn, Sn, and Cu.

44. The rechargeable metal displacement battery of claim 40, wherein the mixture of inorganic salts comprises one or more salts selected from the group consisting of aluminum salts, titanium salts, iron salts, alkali metal salts, alkaline earth metal salts, ammonium salts, and combinations thereof.

45. The rechargeable metal displacement battery of claim 40, wherein the mixture of inorganic salts comprises aluminum salts, and wherein the molar percentage of the aluminum salts is at least 50%.

46. The rechargeable metal displacement battery of claim 40, wherein the mixture of inorganic salts comprises iron salts, and wherein the molar percentage of the iron salts is at least 50%.

47. The rechargeable metal displacement battery of claim 40, wherein the mixture of inorganic salts comprises anions chosen from the group consisting of halides, nitrates, nitrites, sulfates, sulfites, carbonates, hydroxides, and combinations thereof.

48. The rechargeable metal displacement battery of claim 40, wherein the mixture of inorganic salts comprises aluminum chloride, wherein the molar percentage of aluminum chloride is at least 50%.

49. The rechargeable metal displacement battery of claim 40, wherein the mixture of inorganic salts comprises ferric chloride, wherein the molar percentage of ferric chloride is at least 50%.

50. A process for recycling battery scrap containing one or more transition metal oxides comprising:
submerging the battery scrap in a melt comprising a glass-forming oxide;
holding the melt at a temperature between about 600° C. and about 1100° C., thereby allowing the one or more transition metal oxides to dissolve in the melt;
disposing an anode and a first cathode in the melt; and
applying a voltage across the anode and the first cathode, thereby generating oxygen at the anode and electroplating a first transition metal onto the first cathode.

51. The process for recycling battery scrap according to claim 50, wherein the voltage is applied in order to maintain a constant current.

52. The process for recycling battery scrap according to claim 51, further comprising:
continuing to apply voltage to maintain a constant current until a rise in voltage indicates depletion of the first transition metal oxide from the melt; and
removing the first cathode with first electroplated transition metal from the melt.

53. A system configured for monitoring and controlling electrolytic deposition of metal in an electrolytic cell, the electrolytic cell including a positive electrode, a negative electrode, and an electrolyte providing a source of metal ions for electrodeposition onto the negative electrode, the system comprising:
a variable direct current (dc) voltage source configured to receive a first control signal, and to provide a dc voltage across the positive electrode and the negative electrode based on the first control signal;
a variable alternating current source configured to receive a second control signal, and to provide alternating current across the positive electrode and the negative electrode based on the second control signal;
an electrochemical noise monitor configured to monitor current and voltage across the positive electrode and the negative electrode and to produce an output signal indicative of the current and voltage noise across the positive electrode and the negative electrode;
an analysis and control system configured to receive the output signal, and to analyze the output signal to calculate a power spectrum of the noise, and further configured to output the first control signal to the variable de voltage source, and the second control signal to the variable alternating current source, the first control signal and the second control signal being determined based on user-determined input parameters and on the power spectrum of the noise,
wherein the system is configured such that, during operation, the de voltage and the alternating current control the surface features of the metal electrodeposited on the negative electrode based on the first control signal and the second control signal, respectively.

54. The system according to claim 53, the first control signal determining the magnitude and direction of the de voltage.

55. The system according to claim 53, the second control signal determining the magnitude and frequency of the alternating current.

56. The system according to claim 53, wherein the metal electrodeposited on the negative electrode comprises lithium.

57. The system according to claim 53, wherein the electrolytic cell is a rechargeable lithium metal battery.

58. The system according to claim 53, wherein, during operation, the dc voltage and the alternating current are controlled by the first control signal and the second control signal in order to reduce dendrite formation.

59. The system according to claim 53, wherein, during operation, the dc voltage is reversed in order to reduce dendrite formation.
